(19) United States
(12) Patent Application Publication
(10) Pub. No.: US 2026/0179144 A1
(43) Pub. Date: Jun. 25, 2026

(54) BLOCKCHAIN-BASED DECENTRALIZED EXCHANGE (DEX) SYSTEM AND METHOD FOR VIRTUAL ELECTRICITY TRADING

(71) Applicant: Watt2Trade S.A.P.I de C.V., CDMX (MX)

(72) Inventor: Carlos Aurelio Hernández González, Huixquilucan (MX)

(21) Appl. No.: 18/988,089

(22) Filed: Dec. 19, 2024

(51) Int. Cl. G06Q 40/04; G06Q 30/0283; G06Q 50/06; H04L 9/00

(52) U.S. Cl. CPC G06Q 40/04; G06Q 30/0283; G06Q 50/06; H04L 9/50

(57) ABSTRACT

A system and method for blockchain-based decentralized exchange (DEX) for electricity trading, allows a faster liquidation of transactions, reduces costs, eliminates intermediaries and democratizes access to electricity trading, facilitating the participation of users with lower capital. Based on smart contracts, the platform automates and schedules energy transactions, optimizing execution and liquidation times, while improving market transparency and efficiency. In addition, it incorporates floor and cap prices in the electricity markets, guaranteeing security and liquidity of transactions. The integration of futures and options on the platform ensures efficient liquidation of trades. The platform offers its own exchange system with automatic peer-to-peer liquidation, eliminating the need for central authorities. Integrated non-custodial wallets support cryptocurrencies allow staking and facilitate management of operations. Likewise, the platform uses its own native token that grants discounts and voting rights, and operates with amounts from one kilowatt, limiting the maximum loss based on the available liquidity.

### TECHNICAL FIELD

The present invention relates to a system, particularly, a Decentralized Exchange (DEX) platform that is located in the field of Decentralized Finance (DeFi) and uses blockchain technology.

### BACKGROUND

Blockchain and decentralized finance (DeFi) are significantly transforming the field of financial transactions by offering new forms of security, efficiency, and access to financial services. In particular, blockchain-assisted electricity trading is emerging as an innovation in the energy field, promoting efficiency, transparency and accessibility.

There are two main types of platforms for the trading of digital assets: centralized (CEX) and decentralized (DEX) ones. Centralized electricity exchange (CEX) platforms serve as meeting points for the purchase and sale of energy, using smart contracts to execute transactions between producers, distributors, and consumers under the supervision of a central entity. Although these platforms provide a structured and regulated framework for order reconciliation and transaction liquidation, they can also involve third-party dependency and longer liquidation times compared to decentralized solutions.

Decentralized exchange (DEX) platforms, on the other hand, seek to offer greater transparency in energy trading and address the limitations of the centralized model, such as market complexity and the need for information. Unlike CEXs, DEXs allow for the direct trading of digital assets between peers without a centralized authority. In the context of energy, a DEX would facilitate the direct purchase and sale of electricity between producers, consumers and other market participants.

Despite the growing popularity of blockchain-based platforms for electricity trading, there are still few that provide liquidity and hedging options for participants or end users. Efforts to combine electricity with blockchain have focused on large generating and consumer companies, developing centralized technology platforms, without allowing users to coexist in energy transactions in a decentralized way.

For example, to participate in the electricity markets of North America or Europe, authorizations issued by the corresponding regulators, high working capital and guarantees are required. This limits the participation of companies and potential users as it is directly related to their financial capabilities. Since the markets calculate the total possible credit exposure based on the operations carried out, the liquidation period, during which the collections and payments of the purchase and sale of energy are made, can vary according to the market, ranging from 7 to 45 days.

As another example, in Europe, although 22 countries allow private investment with variable market prices, only a few markets allow operations through brokers. In the same way, each market has its own restrictions on activating participants and credit exposure requirements.

There are also international energy futures markets that allow transactions without knowing the counterparties through authorized intermediaries, who approve the offers to buy and sell, liquidate the offers, and allow the entry of users, whether market participants or speculators.

To participate in the physical or virtual electricity trading, it is necessary to sign a contract with a company, assume fixed monthly costs for the use of its software, and be authorized in the different markets. Financial guarantees must also be deposited through banking institutions or clearing houses, which charge additional costs. These fixed and capital costs create a significant barrier to entry for users interested in the electricity market.

It is evident that the structure and transactions in the electricity markets require large amounts of capital, limiting decentralized and accessible participation for independent users. Currently, electricity trading is restricted to large companies and market participants with significant resources, concentrating transactions among a few with large capitals.

As a result, today, there are few platforms capable of simplifying and streamlining electricity trading in financial markets based on the price of energy.

An example of this is the platform described in document IN202411012600, which details a crypto-asset or cryptocurrency trading platform, where smart contracts facilitate international transactions of these assets. However, this platform does not support virtual transactions of electrical energy. Its main function is to allow users to trade coins or tokens between different chains, facilitating cross-border transactions without intermediaries. Despite their advantages in the field of cryptocurrencies, these platforms have the disadvantage of not offering solutions for the growing electricity trading market, being focused exclusively on crypto assets.

Other platforms that use DEX technology for the DeFi field are similar to the platform described in document IN202341070142, which provides a decentralized electricity trading system using a platform architecture (ETPA), in which the decentralized electricity trading platform is composed of a plurality of prosumers, each prosumer is a user with a real-time electricity demand and supply, having access to the network to provide a consensus-based peer-to-peer transaction.

In this case, it is a platform that uses physical electrical energy assets in the form of “prosumers”: users of electrical energy who produce and consume electrical energy, who have surpluses and shortages in their daily electrical supply. This type of platform does not have a focus on virtual futures and options transactions, since they do not allow the trading at different times for certain periods, without liquidating in real time demands, supply, or generation of electrical energy; rather, they have a focus on the monitoring of measurement systems, demand or electrical supply in real time. This application, while useful in certain fields, does not have a particular focus on financial markets based on energy prices, such as futures and options, where participants in these markets do not necessarily buy or sell physical energy, but can speculate on price movements.

In the technical field, there are also platforms such as the one described in document CN116664255A, which refers to a type of method and system of blockchain-based trading digital assets, with which, digital assets in the market are fixed at the equilibrium price, where the price and equilibrium exchange rate of the digital asset are determined automatically, which guarantees the optimal allocation of the asset in the market.

It is important to note that these types of platforms make asset purchases directly according to the price of the same and do not allow Peer-to-Peer transactions between two users, but rather the transactions are handled as physical purchases through permissions in the stock markets. Likewise, the platform of CN116664255A determines, through the use of smart contracts, the price of the digital asset according to supply and demand, without taking into account the resulting prices of electricity obtained from the central authorities operating in the specific electricity market, which does not allow such a platform to guarantee liquidity or provide guarantees of maximum and minimum loss.

Finally, there are also platforms such as the one described in CN116664244A, which implements a method for distributed energy quote transactions and a blockchain-based distributed energy transaction system and a least squares LSTM (long short-term memory). This system can reveal transparent characteristics through blockchain technology, forming a seller quote via an artificial intelligence algorithm based on a decentralized exchange (DEX) platform, allowing the seller to display the quote to the entire network and enabling all parties to complete energy liquidation under the premise of secure and reliable data exchange.

This type of platform essentially refers to a blockchain quote of photovoltaic systems, which are quoted with artificial intelligence using market variables of the physical position of the buyer, exchanging proposals for the construction and commissioning of distributed generation systems. That is, these types of platforms do not have the focus on the trading of virtual energy, in the same way that this was mentioned for the platform of IN 202341070142. On the contrary, these types of platforms do not allow liquidations in the form of futures or options, and, therefore, do not allow to insure the maximum loss designated to add liquidity. In addition, these platforms do not base their operation on a DEX platform, but, rather, energy quotes are generated by sellers who have a distributed generation system, the quotes are then sent to the buyers, where both parties must accept the transaction—that is, the transactions are not published on a DEX platform where any user, regardless of whether they have distributed generation or not, could match an offer, which leads to the disadvantage of not taking into account the prices of the electricity markets, already mentioned for other state-of-the-art platforms.

### SUMMARY

Addressing the shortcomings of the current state-of-the-art and challenges in the electricity market, a system and method for blockchain-based decentralized exchange (DEX) for electricity trading has been conceived. In particular, the invention refers to a DEX platform for electricity trading, which offers a faster liquidation of transactions, eliminates the dependence on intermediaries, reduces costs and simplifies access for participants in the electricity market, democratizing access to electricity trading for users who do not have high amounts of financial capital, or who do not have the possibility of being authorized before the different markets.

The present invention focuses on the trading of virtual energy by implementing smart contracts. Such smart contracts enable the automation and programming of the terms and conditions for each electricity transaction, removing the need for a central intermediary by embedding the rules directly into the protocol, thereby significantly speeding up transaction execution and liquidation.

By leveraging the inherent efficiency of blockchain technology, smart contracts facilitate noticeably shorter liquidation times compared to traditional centralized processes. This method not only optimizes the process, but also improves the efficiency and transparency of the decentralized electricity market, providing an innovative and efficient alternative to conventional centralized platforms. Additionally, the use of smart contracts allows the reduction or even elimination of intermediaries in the electricity trading.

Notably, this innovative platform for electricity trading stands out for its integration of floor and cap prices from electricity markets, ensuring transaction security and guaranteeing liquidity in a simplified manner. It also enables the instant liquidation of transactions, consolidating in a single transaction both the time and the participation of various financial and regulated entities, thus facilitating their execution in a peer-to-peer environment.

Another innovative feature of the invention is the use of futures and options positions to ensure efficiency in transaction liquidation.

The platform employs the Polygon® Mainnet network in combination with the Ethereum® blockchain, facilitating seamless trading, expeditious liquidation, accessible operating capital, and a reduction in necessary financial guarantees. Thus, transactions in the blockchain are validated and cleared immediately, with automatic liquidation without the need for a central authority.

Additionally, the platform features its own blockchain-based exchange with smart contracts specifically designed for energy trading and non-custodial wallets integrated into the platform, offering an accessible, non-custodial interface that seamlessly integrates with the exchange. Wallets support a variety of cryptocurrencies, allowing users to track energy transactions, manage trades, and perform staking. Likewise, users can recharge funds and withdraw money from these wallets through web services, facilitating their use and accessibility.

Unlike other state-of-the-art platforms that only enable electricity transactions using FIAT currencies, this platform leverages its own exchange to allow for automatic liquidation directly with the counterparty, peer-to-peer, without the involvement of a central authority. In this way, both parties ensure liquidity in each transaction with their maximum loss.

Another advantage of this platform is its ability to operate with amounts starting from one (1) kilowatt, limiting the maximum loss determined by the maximum and minimum prices established by the platform liquidity through a native token. This token, called ‘Wattoin’ is a utility token that provides discounts on energy transactions and grants voting rights in operational decisions and bids in various electricity markets.

The features of the invention are described in detail below.

### BRIEF DESCRIPTION OF THE DRAWINGS

The present invention is explained in more detail below with reference to the Figures:

FIG. 1 shows the main menu of the platform of the present invention.

FIG. 2 is the user interface of the wallet of the platform of the present invention.

FIG. 3 is the user interface of the Trading Tab of the exchange of the platform of the present invention.

FIG. 4 is the user interface corresponding to the “Recent Trades” portion of the Trading Tab of the exchange of the platform of the present invention.

FIG. 5A is the user interface corresponding to a first screen of the Add New Order section of the “Recent Trades” portion of the Trading Tab of the exchange of the platform of the present invention.

FIG. 5B is the user interface corresponding to a second screen of the Add New Order section of the “Recent Trades” portion of the Trading Tab of the exchange of the platform of the present invention.

FIG. 5C is the user interface corresponding to a third screen of the Add New Order section of the “Recent Trades” portion of the Trading Tab of the exchange of the platform of the present invention.

FIG. 5D is the user interface corresponding to a fourth screen of the Add New Order section of the “Recent Trades” portion of the Trading Tab of the exchange of the platform of the present invention.

FIGS. 5E-5K illustrate the user interface corresponding to an alternative embodiment of the user interface of the Add New Order section of the “Recent Trades” portion of the Trading Tab of the exchange of the platform of the present invention.

FIG. 6 is the user interface corresponding to the View Details section of an order of the “Recent Trades” portion of the Trading Tab of the exchange of the platform of the present invention.

FIG. 7A is the user interface corresponding to a second view of the “Recent Trades” portion of the Trading Tab of the exchange of the platform of the present invention, where liquidated orders are shown.

FIG. 7B is the user interface corresponding to a first screen of the Withdraw Funds section of the “Recent Trades” portion of the Trading Tab of the exchange of the platform of the present invention.

FIG. 7C is the user interface corresponding to a second screen of the Withdraw Funds section of the “Recent Trades” portion of the Trading Tab of the exchange of the platform of the present invention.

FIG. 7D is the user interface corresponding to a screen of the View Details section following a Withdraw Funds order of the “Recent Trades” portion of the Trading Tab of the exchange of the platform of the present invention.

FIG. 8A is the user interface corresponding to a first screen of the “Electricity Prices” portion of the Trading Tab of the exchange of the platform of the present invention.

FIG. 8B is the user interface corresponding to a second screen of the “Electricity Prices” portion of the Trading Tab of the exchange of the platform of the present invention.

FIG. 8C is the user interface corresponding to a third screen of the “Electricity Prices” portion of the Trading Tab of the exchange of the platform of the present invention.

FIG. 9 is the user interface corresponding to a screen of the “Market News” portion of the Trading Tab of the exchange of the platform of the present invention.

FIG. 10 is the user interface of the Analytics tab of the exchange of the platform of the present invention.

FIG. 11 is the user interface of the Information tab of the exchange of the platform of the present invention.

FIG. 12A is the user interface corresponding to a first screen of the Live Orders portion of the Information Tab of the exchange of the platform of the present invention.

FIG. 12B is the user interface corresponding to a second screen of the Live Orders portion of the Information Tab of the exchange of the platform of the present invention.

FIG. 13A is the user interface corresponding to a first screen of the Market Overview portion of the Information Tab of the exchange of the platform of the present invention.

FIG. 13B is the user interface corresponding to a second screen of the Market Overview portion of the Information Tab of the exchange of the platform of the present invention.

FIG. 14A is the user interface corresponding to a first screen of the Leader Boards portion of the Information Tab of the exchange of the platform of the present invention.

FIG. 14B is the user interface corresponding to a second screen of the Leader Boards portion of the Information Tab of the exchange of the platform of the present invention.

FIG. 15 is the user interface corresponding to the Past Trading Data portion of the Information Tab of the exchange of the platform of the present invention.

FIG. 16 is the user interface of the Staking tab of the exchange of the platform of the present invention.

### DETAILED DESCRIPTION OF THE INVENTION

In the present application, a system, particularly, a platform based on smart contracts and blockchain, that allows users to trade with electricity is described. It describes a decentralized market (DEX) where you can place electricity futures orders (DAILIES), manage electricity prices per day and market, as well as staking and unstacking coins.

The system allows you to place, cancel and withdraw electricity orders, with complex calculations related to prices, commissions, and liquidity. The platform also integrates functions that ensure the management of funds and virtual electrical energy transactions and applies reduced rates to those users who use staking to secure their operations.

In addition, the system handles emergency cases, such as pausing operations, and several queries to obtain balances and staking states.

### Platform Ecosystem.

In a main embodiment, the platform of the present invention comprises several sections that refer both to the functional part of the platform (focused on the exchange and trade of electricity), and that provide additional information that is merely informative or illustrative, in order to improve the interaction of users with the platform, enrich their knowledge on the subject of electricity trading, or provide data in a visual and attractive way.

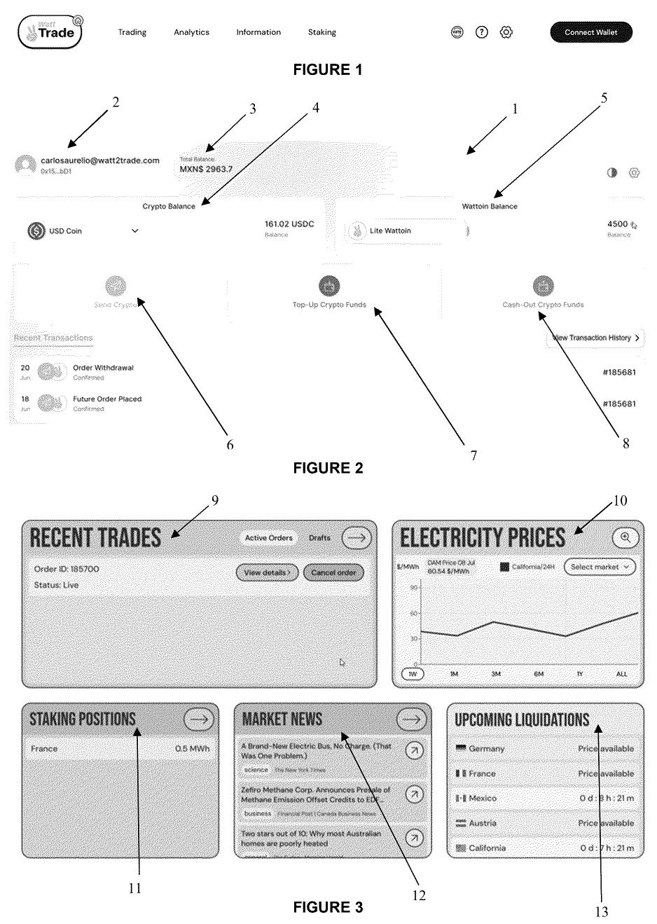

In the main embodiment, the platform comprises the sections shown in FIG. 1, which shows a main menu 1, where the functionalities of the platform are broken down in the form of the following tabs:

Trading, which includes activities related to electricity trading;
Analytics, which shows an analysis of the activities of each user, such as, for example, total volume of energy in trading, total number of orders created, profits and/or losses, and graphs of such information, among other relevant data;
Information, which displays information such as existing live orders, Leader Boards, which show users with more orders created in a span of time; news, electricity prices, and more informative data that may be useful to users; and
Staking, which allows users to stake their tokens, particularly, the native token to the “Wattoin” platform, in exchange for benefits and incentives on the platform.

Likewise, the menu of the main modality comprises quick access buttons that particularly refer to the sections of:
Voting, where users will be able to obtain voting rights in the operational offers and decisions of the different electricity markets;
Frequently Asked Questions, which includes basic manuals for the use of the platform and definition of common concepts and terms in the field of electricity trading, and
Settings, which includes specific settings for each user, such as the possibility of adjusting what is to be displayed on the platform when selecting a level of user experience (basic or professional), or the currency and/or markets that will be displayed in the interface of the platform by default for each user's profile.

Finally, the menu includes the Connect Wallet button, which allows linking to the platform account of an external wallet, or the authentication of users using the functionalities of Web3Auth® technology.

It is noted that the Voting, Frequently Asked Questions and Settings sections are optional on the platform, and although they are not fundamental features for the operation of the decentralized exchange platform with the strict purpose of electricity trading, they provide added value for users by providing supporting information and allowing users to actively participate in innovations on the platform, which supports the objective of this platform to provide an easy-to-use platform, with accessible information and intuitive use for non-expert users in the field of electricity trading.

In view of this, these elements will not be detailed later in this application, as they are not essential for the platform to operate properly fulfilling its purpose.

In alternative embodiments of the invention, it is possible that the menu contains additional elements that may be useful to users, or, conversely, that some of the buttons or tabs mentioned above are not included.

However, particularly in terms of the operation of this platform as a platform for electricity trading, it comprises the following crucial elements: a wallet, an exchange where trading operations are carried out, and the native token of the platform (“Wattoin”).

### Wallet.

The particular wallet of the invention provides an easy-to-use, non-custodial gateway to the ecosystem, which integrates seamlessly with the exchange of the platform. It supports a variety of cryptocurrencies and allows users to track their energy transactions, manage transactions, and make stake. The wallet is designed for ease of use and security.

The wallet is designed for users new to cryptocurrencies and blockchain, offering a simple experience and without the need to delve into technical details. As a non-custodial wallet, it allows users to maintain full control over their assets.

The wallet's user interface is designed to hide the complexities of the blockchain behind a minimalist and intuitive design. It shows essential information such as balances in cryptocurrencies traded on the DEX, which could be, for example and in a non-limiting way: ETH, wBTC, USDT, USDC and MATIC; energy balance of the native token of the platform (Wattoin) and energy coins linked to the DEX; futures positions; a detailed history of transactions.

The integration of the wallet with the exchange of the platform is harmonious, offering a smooth transition between asset management and trading.

The wallet uses the functionalities of Web3Auth® technology that facilitates secure logins and key management. Since Web3Auth® supports traditional wallets, such as MetaMask or WalletConnect, this allows users to connect to the platform flexibly. Likewise, since users can authenticate with their social accounts, it is easier to regain access if they lose the device or do not remember their private key, something that is a common problem in purely decentralized applications.

The wallet also allows users to easily top up their cryptocurrency balances with fiat money, and vice versa, convert cryptocurrencies back to fiat money, with the support of third-party services. It also supports sending cryptocurrencies to other addresses, being a versatile tool for digital finance.

This non-custodial wallet is not intended as a standalone product intended to compete with platforms such as Coinbase® or Binance®. Instead, it is the gateway for people who have little knowledge about cryptocurrencies to enter the decentralized exchange (DEX).

The DEX functionality is visually prioritized, while other aspects of the blockchain are hidden by default. In addition, it uses Web2 terminology instead of Web3 when it facilitates understanding for users.

The key functionalities of the wallet of the platform in question are the following:

The first functionality of the wallet is authentication: the wallet's authentication system is based on Web3Auth®, allowing you to manage tasks such as login, password reset and login efficiently. Web3Auth® supports multiple authentication methods, including login with social media accounts, which simplifies the process for users. In addition, the handling of private keys is managed transparently, allowing users not to have to deal with the complexity of cryptographic keys.

In one embodiment, the wallet authentication system has the possibility to log in using biometric authentication, such as facial recognition or fingerprint; and users can log out of the wallet securely from any device.

In general terms, user sessions are managed efficiently, ensuring a continuous and safe experience on different devices.

Another functionality is the core of the wallet: since the wallet is based on Web3Auth® for account creation and key management, users can easily and securely create their wallets. In addition, it offers the ability to log into the wallet from any device (mobile or web) and integrate seamlessly with the DEX, providing total flexibility to the user.

In one embodiment, the wallet includes integration with Sendwyre® to facilitate conversion between cryptocurrencies and FIAT money (on-ramp and off-ramp), which improves the accessibility and usability of the wallet within the financial ecosystem.

Yet another feature is cryptocurrency transfers: the wallet allows cryptocurrency transfers to be made, both to send and to receive. Users receive notifications within the wallet on the platform when transfers are completed, with specific notifications for transactions generated by operations within the DEX, providing immediate visibility of their funds.

Another functionality of the wallet is the balances and transaction history: the wallet shows the balances of the cryptocurrencies and other assets of the user in the specific network supported by the DEX, particularly, Polygon®.

Users can view: The balances of specific currencies, including those related to the electricity trading platform (“Wattoin” of the DEX equivalent to 1 kilowatt).

The balances related to coin staking, originating from the staking smart contract, which will be detailed further below.

The detailed history of all transactions made with the wallet, not only cryptocurrency transfers, but also transactions related to DEX smart contracts, such as electricity trading. The active or pending operations in the DEX will also be displayed using data from the DEX API.

Other assets such as NFTs and additional coins are not displayed by default or will have a more subtle visual representation.

Another functionality of the wallet is personal data: the wallet will collect and store the user's personal data from the KYC (know your client) processes during the conversion of cryptocurrencies to FIAT (on-ramp/off-ramp), as well as the login data using Web3Auth® OAuth®, such as emails and other necessary information.

The main function of the wallet is its compatibility with the DEX of the platform. Not only does it allow users to log into their wallets from different devices, but it also allows them to access the DEX using their wallet. This ensures full integration between the DEX's wallet and trading functions, allowing frictionless trading of electricity and other cryptocurrencies.

FIG. 2 illustrates an exemplary embodiment of the user interface of the wallet 1 of the platform as described in the present application.

The user interface of wallet 1 is an important functionality: both in its mobile and web version, it follows a minimalist and friendly design approach, and can show, in an exemplary and non-limiting way, elements such as:
User data 2, such as email address or registered name;
Total Balance 3, which shows the user's balance in FIAT money;
Crypto Balance 4, which identifies the amount of cryptocurrencies (e.g., ETH, wBTC, USDT, USDC, or MATIC) in the user's account; and
Wattoin Balance 5, which shows the number of native tokens to the platform in the user's possession.

The interface can also display buttons to perform actions from the wallet, such as:
Send Crypto 6, which is used to send cryptocurrencies to other accounts;
Top-Up Crypto Funds 7, to deposit more funds in cryptocurrencies to the wallet within the platform; and
Cash-Out Crypto Funds 8, to convert the user's crypto funds to FIAT money.

In a further embodiment, the interface may also display the “Recent Transactions” section, which displays the user's recent transactions from their wallet.

It is possible to add or remove more functionalities, depending on the needs of the users.

The wallet may also have some additional functionalities:

Support: The wallet includes a support functionality, where users can automatically send a spam-protected email to a specific address. These emails will include information about the reported problem, its severity, and other relevant data.

Automatic email confirmations: Users receive automatic confirmation emails after successful transactions, both in the on-ramp/off-ramp process and in trading operations within the DEX (e.g., electricity trading).

Finally, the wallet is also cross-platform: the wallet is available for both Android and iOS systems, with mobile applications developed for both platforms. It also has a web version, with all the interfaces (mobile and web) connected to the backend to run the functionalities efficiently.

### Exchange.

The main component of the ecosystem of the platform described in this document is the exchange. The platform's own exchange facilitates energy trading. By leveraging the Polygon® network to execute smart contracts, it streamlines transactions to be faster and cheaper, bypassing traditional intermediaries and making them accessible to everyone.

The exchange of the platform allows connections of multiple wallets through the use of the Wallet Connect protocol. Leveraging advanced smart contracts, the platform allows users to engage in strategic and speculative transactions related to energy prices.

The basis of the blockchain-based decentralized exchange (DEX) platform for electricity trading of the present invention are smart contracts, designed to automate and secure the trading process, offering users the ability to take strategic and non-strategic positions on energy prices. These contracts serve as the backbone for transactions, in which no real energy is traded but “synthetic” positions on energy prices. Users interact with these contracts by depositing funds based on specific parameters. Once the electricity price for the specified day is known, participants can withdraw their funds, reflecting gains or losses based on their positions.

The exchange is where the transactions available to users are carried out, and for this, it has a user interface that comprises several elements to make it easier for users to carry out the functions of the platform intuitively.

The exchange is the part that comprises the functionalities of the platform in the form of the Trading, Analytics, Information, and Staking tabs, as will be detailed below.

First, we will start by talking about the portions located in the Trading tab.

FIG. 3 illustrates the user interface of the Trading tab of the exchange 2 of the platform as described in the present application.

The main screen of the Trading tab of the user interface of the exchange can comprise, without limitation, the portions: Recent Trades 9, Electricity Prices 10, Staking Positions 11, Market News 12, and Upcoming Liquidations 13.

These portions have the following functionality:

### a) Recent Trades 9:

Portion that shows the most recent operations or transactions that a user has made on the platform. This may include, but is not limited to, cryptocurrency trades, orders to buy or sell assets, or any trading activity that the user has recently completed.

This portion is also the one that allows users to create new orders. In particular, it allows users to place buy or sell orders for options, place futures orders, or match with existing orders from other users. This portion is operated in the following manner:

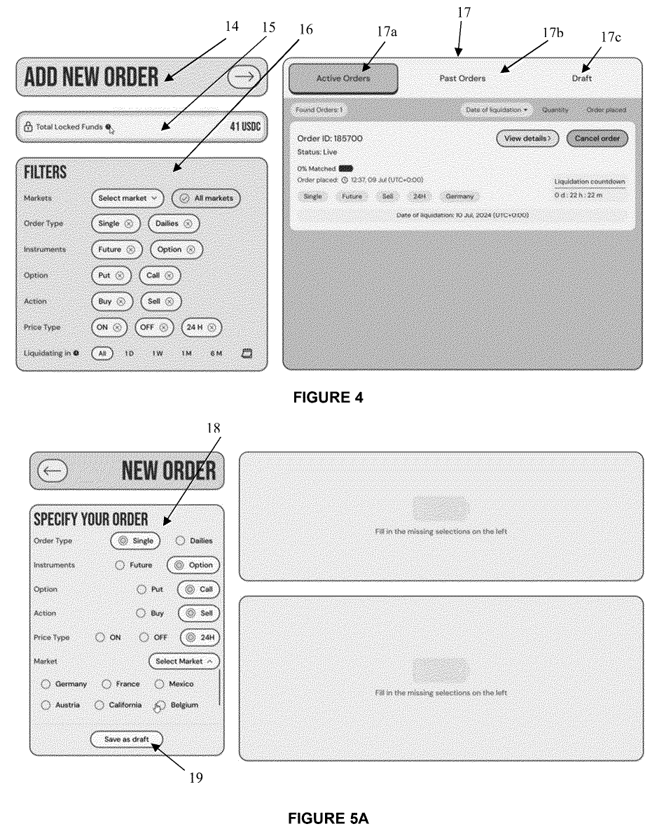

When exploring this portion using the arrow-shaped button (which can alternatively be a button indicating “see more” or any variation) shown in FIG. 3 in the Recent Trades 9 portion, the screen shown in FIG. 4 can be seen, corresponding to the user interface of the Recent Trades 9 portion, which comprises the sections:

Add New Order 14: Main button in the upper left, which allows you to open, from this portion, a new order for a transaction.

Total Locked Funds 15: Indicates the total funds blocked by the user.

Filters 16: Displays the following filters to search among the orders placed:
Markets: Market selector: allows you to select the market in which the requested order was placed;
Order Type: Allows you to filter orders based on options such as Single or Dailies.

Instruments: Allows you to filter orders based on instrument types such as Future and Option.

Option: Put and Call option selection filter.

Action: Buy or Sell option selection filter.

Timeframe: Allows you to filter orders based on time intervals (ON/off) such as 1 day, 1 week, 1 month, 6 months or more.

Liquidating in: Allows you to filter orders based on liquidation intervals.

Section 17 comprising the tabs:

Active Orders 17a: displays the list of active orders of the user, and comprises the following subtabs:

Found Orders: Total number of active orders found.

Date of liquidation: Filter tab that allows you to sort the orders found by the liquidation date.

Quantity: Filter tab that allows you to sort the orders found by the quantity.

Order Placed: Filter tab that allows you to sort the orders found by the date of creation of the order.

In fully or partially liquidated orders, a “Withdraw Funds” button appears, which allows you to withdraw the funds corresponding to the order in question.

Past Orders 17b: displays the list of past orders of the user that are no longer active. It has the same subtabs as the Active Orders 17a tab.

Draft 17c: displays the list of orders in “draft” state of the user. It has the same subtabs as the Active Orders 17a tab.

From the Recent Trades 9 portion, it is possible to open a new order, by selecting the Add new order 14 button.

The display of the interface of the Add new order 14 section will vary depending on whether the “professional” or “beginner” mode has been selected in the Settings portion of the platform. The two visualizations comprise the same filters and require the same operating parameters, however, the “beginner” version will guide the user step by step when opening a new order.

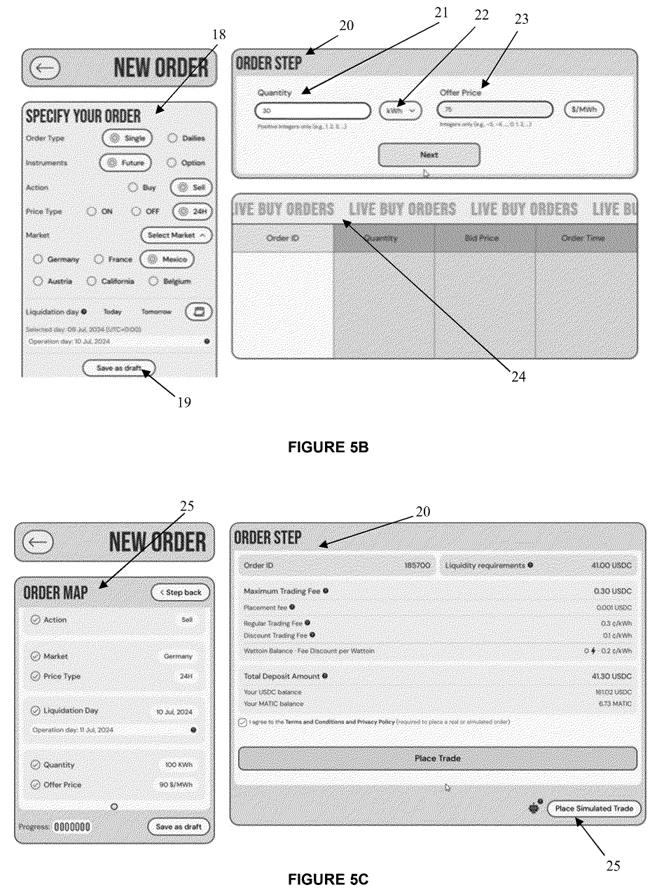

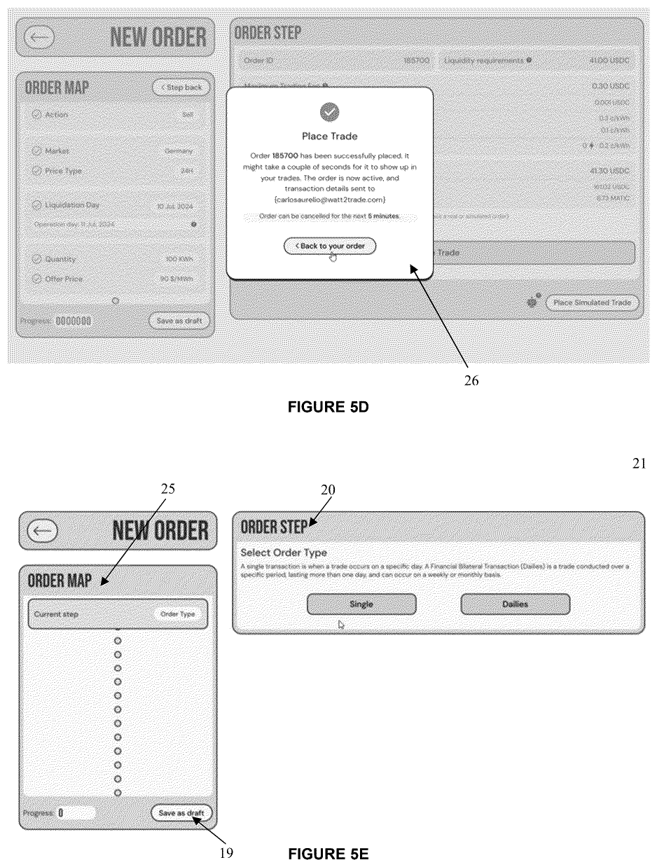

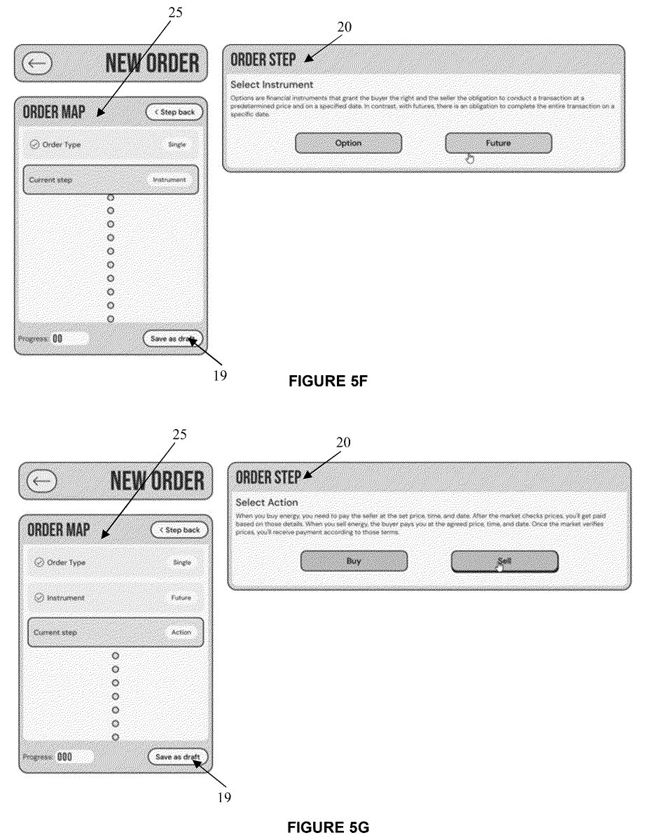

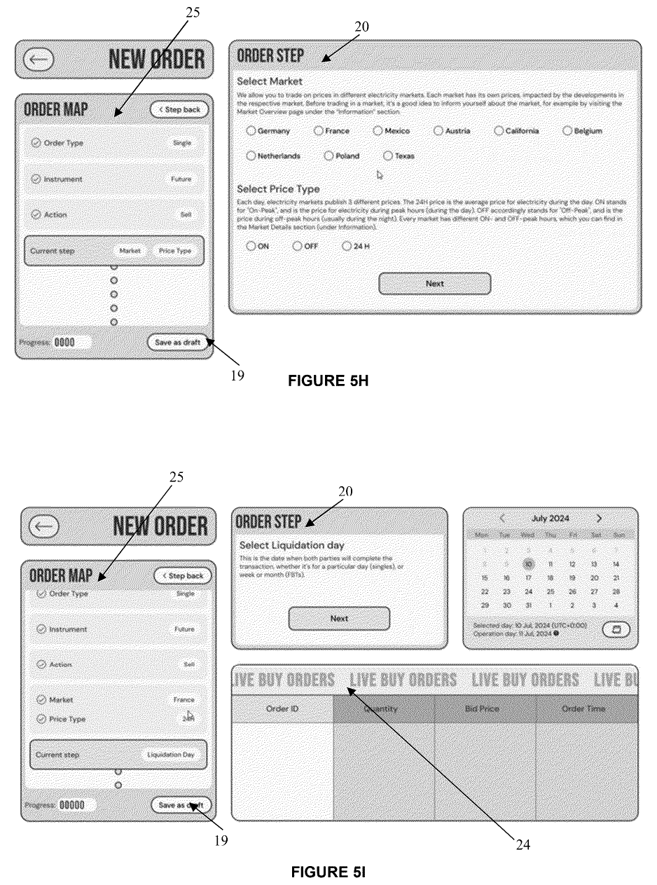

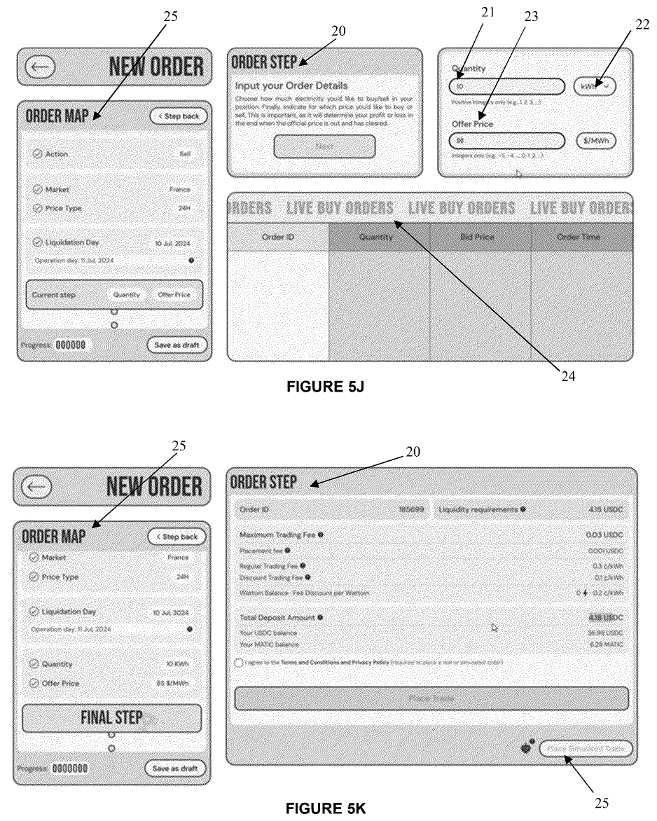

In the “professional” version, the window corresponding to the Add New Order 14 section will open as shown in FIG. 5A, and which comprises the following elements:

Title panel indicating “New Order” and comprising the button to return to the interface of the Recent Trades 9 portion;

Panel Specify Your Order 18, which is used to indicate the details of the order to be created, such as, but not limited to:

Type of order (single or dailies, single for a single day and “dailies” for periods of one week from Sunday to Monday or for a period of one calendar month);

Instruments (futures or options);

Option (put or call): this parameter appears only if the “option” instrument has previously been selected, as can be seen, for example, in FIG. 5A, and is hidden if the selected instrument is “future”, as can be seen in FIG. 5B;

Share (buy or sell);

Type of price (24 hours, on or off); Markets (this section can include the number of markets that are considered useful for trading on the platform, for example, markets such as Germany, France, Mexico, Austria, or any other electricity market of interest to users).

Save as Draft 19 button, which is used to save the order data for later in case you do not want to complete it at the time;

Once the data in the Specify Your Order 18 panel is completed, the interface updates as shown in FIG. 5B. The Specify Your Order panel 18 now also displays the Liquidation Day parameter, which provides a calendar for the user to select the desired order liquidation date. Additionally, it introduces a new panel, Order Step 20, which requires the completion of the following parameters: Quantity 21, corresponding to the amount of energy to be traded, a Unit of Measure selection field 22 (kW or MW), and the Offer price 23. The panel also includes a ‘Next’ button.

Additionally, as shown in FIG. 5B, the interface also shows the new Live Buy Orders 24 panel, which shows orders created live by other users. It is also possible to match orders from this panel.

It is important to note that this is where several of the novel and inventive features of the present platform are executed. Specifically, when users input information in the Offer price 23 parameter, the entered price is validated against the limits established by the market. In other words, this is the point at which the floor and cap prices of the electricity markets are validated for placing an Offer price, which will determine the amount of liquid collateral to be deposited, calculated based on the maximum loss defined by the floor or cap price.

The Offer price input by the users will determine the liquidity to be deposited in the smart contract, which will be based on the maximum possible loss according to the floor and cap prices of each market. If the user does not have the required liquidity to complete a transaction, they will not meet the criteria, and the interface will notify them and prevent them from completing their order placement or matching process.

It is noted that the prices of the electricity markets are programmed separately on the platform, particularly in the Electricity Prices 10 portion of the user interface of the exchange 2, as well as in the Market Overview 33 portion, which will be described later.

Another novel feature appreciable at this point of the interface is that the platform allows selecting the Unit of Measurement 22 to be used, allowing the operation to be carried out both in kW or MW, unlike other platforms of this type, which only allow the use of a single unit of measurement (MW).

Continuing with the process of placing an order, when entering the requested values and pressing the “next” button, the interface is updated again as shown in FIG. 5C, removing the Specify Your Order 18 panel and replacing it with a new Order Map 25 panel, which shows the previously selected parameters of the created order, and updating the Order Step 20 panel to show the data corresponding to the order to be created, such as the order number (Order ID), liquidity requirements, maximum trading fee, placement fee, Regular Trading Fee, Discount Trading Fee, Wattoin Balance/Fee discount per Wattoin (later it will be explained how the use of the native token of the “Wattoin” platform is taken into consideration to obtain discounts on orders), and other data relevant to the order made.

Also, the Place Trade button appears, with which the order is officially created when the user reviews the order data, and presses it.

It is noted that the platform of the present invention also provides a novel option to Make a Simulated Order 25, as shown in FIG. 5C, which allows a user to have the opportunity to see what an order placed with the selected parameters would be like, before genuinely placing the order.

When the user presses the Place Trade button, a Confirmation Window 26 will appear as shown in FIG. 5D, confirming that the order has been successfully created and showing a reminder that the order can be canceled in the following minutes (using the “Cancel Order” functionality that will appear for each order in the order list in the Active Orders 17a panel), and when pressing the Back to your Order button of said Confirmation Window 26, the order is displayed in the Active Orders 17a panel in section 17 of the interface of the Recent Trades 9 portion as shown in FIG. 4.

It is noted that the steps that are carried out to raise an order in the display of the platform in “beginner” adjustment mode can be seen step by step in FIGS. 5E-5K, in which only the display of the filters that in the “professional” version appear in the Specify Your Order 18 panel changes.

Specifically with respect to the “Cancel Order” functionality, it is noted that the platform of the present invention allows a user to cancel their order if they regret it, however, this possibility will only be available a few minutes (for example, 5 minutes) after the activation of an order.

In addition to the “Cancel Order” functionality, there is also an “Emergency Pause” functionality for creating an order. This functionality is critical to ensuring the safety and stability of the electricity DEX. It allows administrators to manage emergency situations, perform maintenance, and ensure that transactions are handled responsibly and transparently, thus protecting the interests of users and the integrity of the market.

This function is activated by the administrators of the decentralized exchange platform of the present invention, without the user being able to cancel this event, and is used in cases such as those related to security and fraud prevention (situations where suspicious behavior or fraudulent activities are detected), system maintenance (to avoid errors or inconsistencies during maintenance), market conditions (during periods of high volatility in the electricity market, pausing operations can be beneficial to prevent users from carrying out transactions at inappropriate prices, thus protecting their interests), or any other emergency situation that warrants it.

However, in the interface of the Recent Trades 9 portion shown in FIG. 4, it can be seen that the orders in the list of any of the Active Orders 17a, Past Orders 17b or Draft 17c panels of Section 17 comprise brief data such as the order number (Order ID), the order state (for example, “live”), and also comprise the “View details” and “Cancel order” buttons.

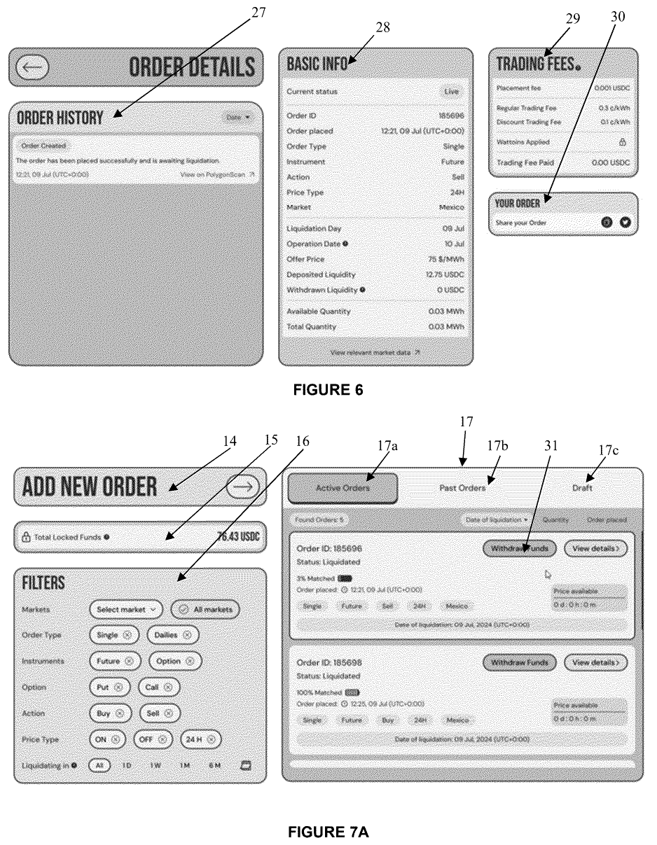

By selecting the “View Details” button on any one of the orders in the list of any of the Active Orders 17a, Past Orders 17b or Draft 17c panels of Section 17, the interface will change to look as shown in FIG. 6, showing the following elements:

Panel Order Details: Main title at top;

Panel Order History 27: It shows the history of the order, with information such as the status of the order, the time and date of the creation of the order. In an embodiment, this element may comprise the “View on PolygonScan” element: a link to view the transaction in the blockchain browser.

Panel Basic Info 28: Central panel with key details of the order, which shows particular details of the order, such as, but not limited to: Current Status, Order ID, Order placed, Order Type, Instrument, Action, Price Type, Market, Liquidation Day, Operation Date, Offer price, Deposited Liquidity, Withdrawn Liquidity, Available Quantity, Total Quantity, Repeat Order (to place an order equal to the existing one), among others.

Panel Trading Fees 29: Panel on the right, which includes order data related to the fees associated with this order, such as Placement fee, Regular Trading Fee, Discount Trading Fee, Wattoins Applied, Trading Fee Paid, among others.

Your Order Panel 30: includes the “Share your Order” option, which allows you to share the order on social networks, or copy the order link on the platform.

In addition, from the Recent Trades 9 portion it is possible to withdraw the funds of those orders that have already been fully or partially liquidated.

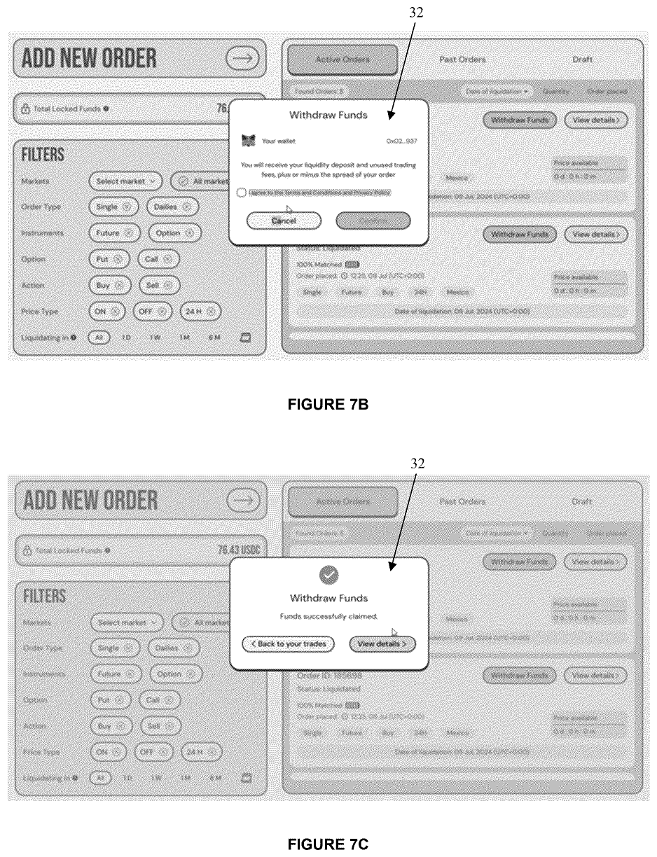

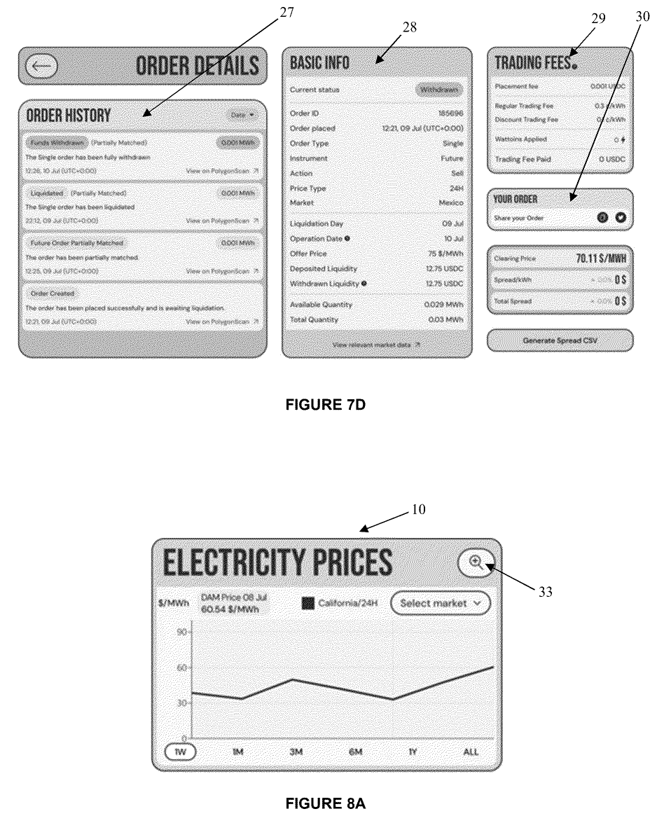

In FIG. 7A, the display of the screen corresponding to the user interface of the Recent Trades 9 portion is illustrated, similar to that shown in FIG. 4, but which now shows in the Active Orders 17a panel in section 17 several orders that have been totally or partially liquidated, which have the Withdraw Funds 31 button activated.

To withdraw the funds from a liquidated or partially liquidated order, the user must click on the Withdraw Funds 31 button, which will open a Withdraw Funds 32 pop-up window as shown in FIG. 7B.

In this pop-up window Withdraw Funds 32 will appear the information regarding the wallet linked to the user's account, and Cancel and Confirm buttons. Pressing the Confirm button starts the transfer of the available funds from the contract to the user wallet.

The action of withdrawing funds from a liquidated or partially liquidated order is governed by a smart contract, which is configured to distribute in proportional shares according to the formulas that will be described later, so that each user who has matched the order in question receives his corresponding proportional share of the funds generated.

After confirming the wallet to which the funds will be transferred, the Withdraw Funds pop-up window 32 will change to as seen in FIG. 7C, showing a transaction confirmation window, and also showing two buttons: Back To Your Trades and View Details, where the Back To Your Trades button will return the user to the interface of FIG. 7A, and the View Details button will refer the user to the interface of FIG. 7D, which is very similar to the interface of FIG. 6, and comprising the Order Details, Order History 27, Basic Info 28, Trading Fees 29, and Your Order 30 panels; but which also comprises a panel that indicates the Clearing Price (price at which the order was liquidated), Spread and Total Spread, which indicate the difference generated by the order in question in kWh and in currency.

Also, the Generate Spread CSV button appears, which allows you to generate a document in the form of a data table that breaks down the Spread of the order in detail, for the convenience of the users.

It is noted that this operation also shows the “Cancel Order” functionality, where the platform allows a user to cancel their order if they regret it, within a few minutes after the activation of said order.

Additionally, the “Emergency Pause” functionality for creating an order is also applicable for this process, as mentioned in previous paragraphs.

### b) Electricity Prices 10:

Another portion of the “Trading” tab is “Electricity Prices 10”, which is used to see the electricity prices of different markets loaded on the platform.

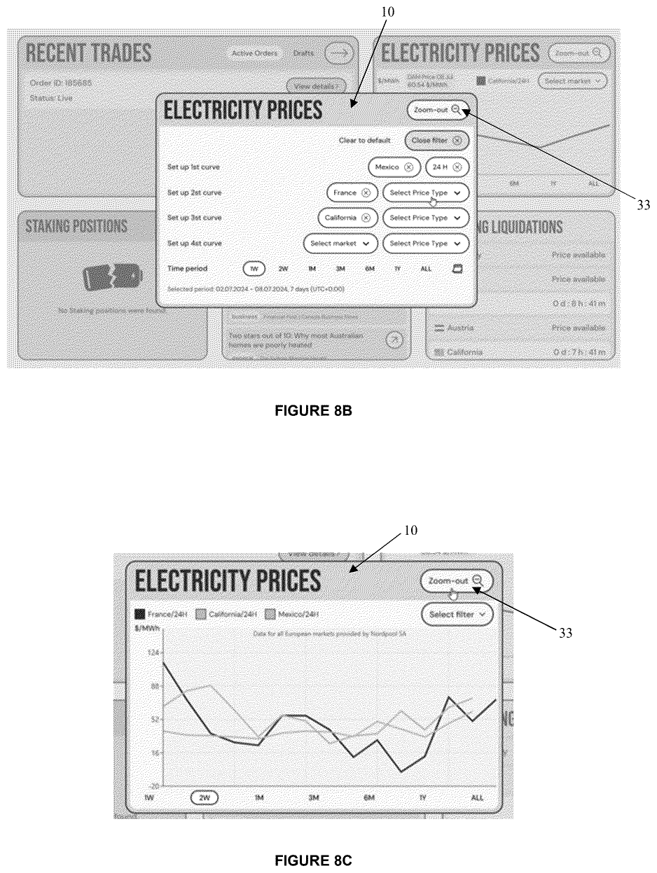

In FIG. 8A, this section is shown in more detail, identifying the Zoom In/Zoom Out button 33, as well as a MW/price ratio graph, and a drop-down list of the markets that can be selected to be shown in the graph.

By clicking on the Zoom In/Zoom Out button 33, the Electricity Prices 10 portion pops out as a pop-up window, and instead of the graph, filters appear to configure what said graph projects, as this is shown in FIG. 8B.

In a non-limiting way, the filters can be up to four curves for different markets, but these can be more or less, depending on the needs of the users. Each “curve” filter corresponds to the electricity market of a country, for example, Mexico, France, or any other of the markets available on the platform. Each curve filter also allows you to select the price type, such as 24H, which corresponds to 24 hours.

There is also a Time Period filter, which allows you to select, without limitation, 1 week (1 W), 2 weeks (2 W), 1 month (1 M), 3 months (3 M), 6 months (6 M), 1 year (1 Y) or all (ALL). In addition, there are “Clear to default” and “Close filter” options to confirm the selection of applied filters.

When pressing the “Close Filter” button, the selected parameters are confirmed, and a graph is shown as shown in FIG. 8C, showing the selected information in the form of a graph.

Finally, by pressing the Zoom In/Zoom Out button 33 again, the Electricity Prices portion 10 returns to the general interface shown in FIG. 3.

It is worth mentioning that the platform uses a specific smart contract to monitor and present the updated prices of the electricity markets of several countries. This contract stores all electricity prices, for all markets, all types of prices, every day. All Escrow Smart contracts query this contract for pricing data, by querying energy pricing APIs, and the DEX backend.

The configuration of this smart contract allows the validation of the floor and cap prices of the electricity markets for the order placement by users.

### c) Staking Positions 11:

The Staking Positions 11 portion of the user interface of the Trading tab of the exchange 2 of the platform shows the positions of the leading users in staking the native token of the Wattoin platform. This section is optional on the platform, and although it does not correspond to a fundamental feature for electricity trading, it provides added value to the platform by making user participation more interactive, supporting the objective of the present invention to provide an easy-to-use platform, with accessible information and intuitive use for non-expert users in the field of electricity trading.

### d) Market News 12:

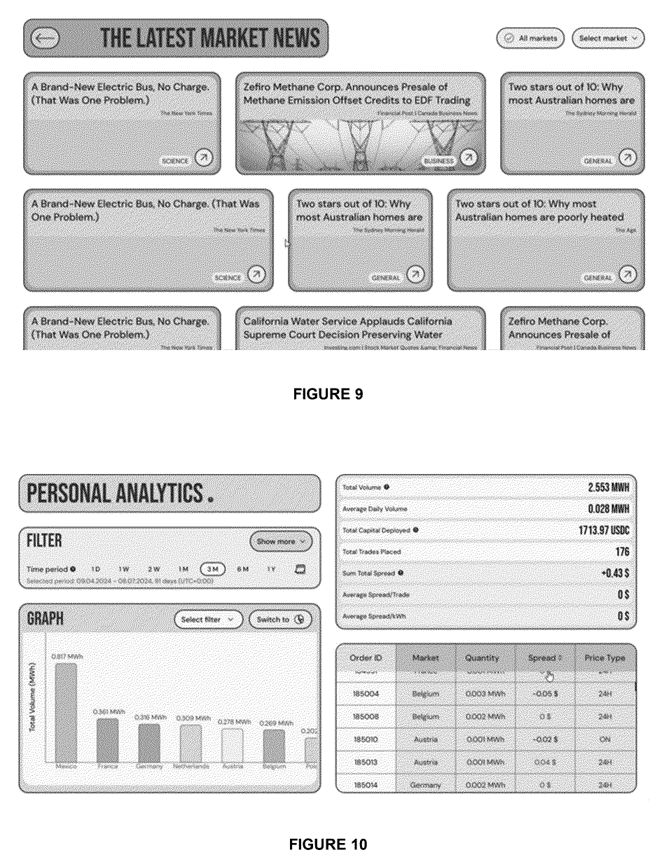

As with the Staking Positions 11 portion, this portion is merely informative to users and is configured to collect and display recent news related to global electricity markets. The general interface of this section is shown in FIG. 9.

### e) Upcoming Liquidations 13:

Finally, the Upcoming Liquidations 13 portion of the user interface of the Trading tab of the exchange 2 of the platform shows events where future contracts or leveraged positions will be liquidated in the near future, in order to allow users to match these contracts or positions.

However, another tab of the exchange 2 of the platform as described in the present application is the Analytics tab:

This tab includes information regarding the personal statistics of each user, such as the total number of orders created, Total volume of electricity marketed by the user, total profits, among others. The information on this tab is mainly informative for users, and has the advantage of showing each user in an easily identifiable and accessible way information about their activity on the platform, such as their profits or losses, a list of their created orders, etc.

FIG. 10 illustrates the user interface of the Analytics tab, showing the following elements:
Main title panel at top;
Panel Filter: comprises a selection of parameters to filter by date, or other parameters, the orders created by the user;
Graph panel: graph that statistically shows the markets with which the user has interacted the most;

Central information panel: Panel on the right, which includes general data on orders created by the user, total profits or losses, average daily volume traded, total number of orders created, among other data.

Order list panel: it comprises a list of all the orders created by the user, with the identification of the order number (OrderID), the market, the amount of kW or MW traded, losses or profits for each order, the price type used, and optionally, any other value that is considered useful for platform users.

Another tab of the exchange 2 of the platform is the Information tab:

Although this tab mostly comprises information for querying or reference for users, it also comprises two portions that are important for the operation of the platform and that influence the way in which users market electricity, which we will see below.

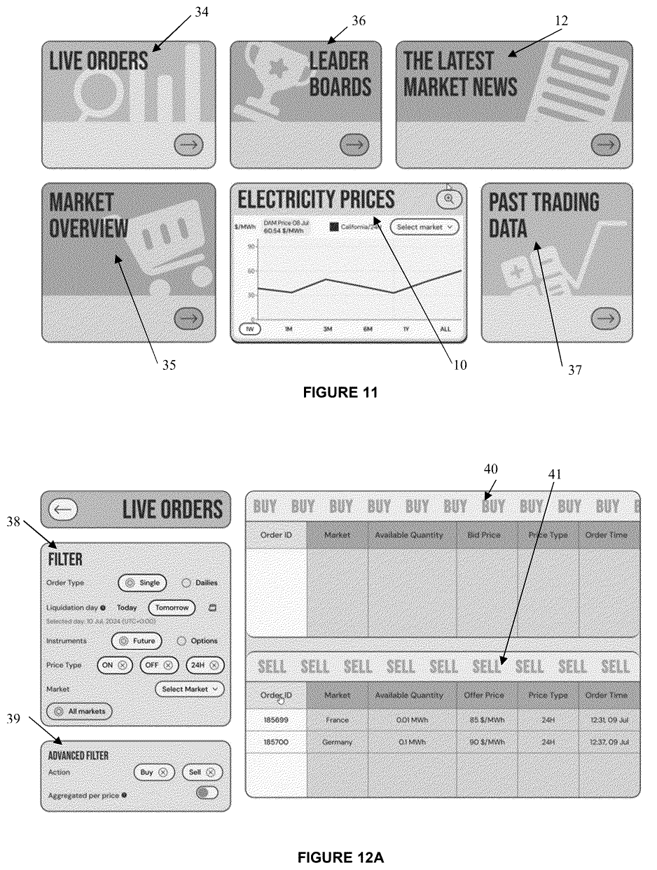

FIG. 11 shows the user interface of the Information tab of the exchange of the platform of the present invention. This interface includes, but is not limited to, the following portions: Live orders 34, Market Overview 35, The Latest Market News 12 (this portion is the same that can be accessed from the user interface of the Trading tab); Leader Boards 36; Electricity Prices 10 (this portion is the same that can be accessed from the user interface of the Trading tab); and Past Trading Data 37.

These elements have the following functionality:

### a) Live Orders 34:

This portion shows the existing live orders on the platform. The interface of this portion is shown in FIG. 12A, and comprises the following elements:

Main title panel at top;

Panel Filter 38: comprises a selection of parameters to filter by type of order, date of liquidation of an order, type of instrument (future or option); price type, market, or any other parameter that may be considered relevant to users.

Panel Advanced Filter 39: comprises filtering parameters additional to the parameters of the panel Filter;

Buy order list panel 40: it comprises general data of the existing buy orders in the platform, which shows data such as the order number, market to which the order applies, available quantity, Offer price, price type, time of the order, or any other data that may be considered relevant.

Sell order list panel 41: it comprises general data of the existing sell orders in the platform, which shows data such as the order number, market to which the order applies, available quantity, Offer price, price type, time of the order, or any other data that may be considered relevant.

The functionality of the Live orders portion 34 is to allow users to view pending live orders on the platform and allow users to match these orders.

The process to match an order consists of clicking on the order number of any of the sales or buy order list panels, which will open a new overlapping window identified with the title Match This Order 42, as shown in FIG. 12B.

In this Match This Order 42 window, the details of the order to be matched will be shown, such as the seller, Offer price, date of placement of order, date of liquidation, time of operation, or any other information that may be relevant to identify the order.

It also shows the amount available, which is the amount of electricity that is available to be bought or sold in the specific order selected.

Based on this available amount, the user can fill the Quantity to Match field 43 with the amount of energy he wishes to match, selecting the amount in kW or MW in the corresponding parameter selector 44, or he can also select the Fully Match Order 45 option, thus matching the entire available amount of the order in question.

To finish the matching, the next button is selected, which will send the user to the interface of FIG. 5C, which allows the match order to be placed when using the Place Trade button, after which the match order is officially created.

When the user presses the Place Trade button, a Confirmation Window 26 will appear as shown in FIG. 5D, confirming that the order has been successfully created and showing a reminder that the order can be canceled in the following minutes, and when pressing the Back to your Order button of said Confirmation Window 26, the order is displayed in the Active Orders 17a panel in section 17 of the interface of the Recent Trades 9 portion as shown in FIG. 4.

### b) Market Overview 35:

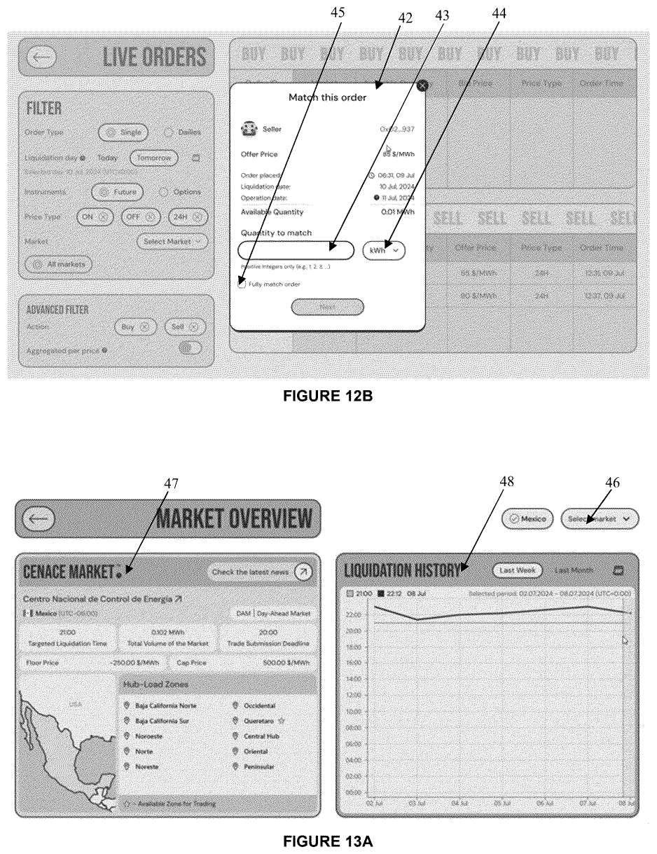

The interface of this portion is shown in FIG. 13A, and in addition to the title, comprises a Market selector menu 46, as well as the Market 47 and Liquidation History 48 panels.

Through the market selector menu 46 it is possible to select the market to be observed, as an example, in FIG. 13A the Mexican market is selected, for which reason in the Market 47 panel “CENACE Market” is indicated since the National Energy Control Center (CENACE) is the entity responsible for the operation and control of the National Electric System in Mexico; and in FIG. 13B the selection of the Texas market is shown, for which reason, the Market 47 section indicates “ERCOT Market”, since the Electric Reliability Council of Texas (ERCOT) is the entity responsible for operating the electricity network in Texas.

The Market panel 47 comprises information regarding the Target Liquidation Time of said market, Total Volume of the selected Market, the Trade Submission Deadline, as well as the floor and cap prices of the selected market, and optionally, it may comprise additional information that is considered useful, such as the indication that the market is a Day-Ahead Market, the schedule used, etc.

In this panel you can see the novel feature of the present invention regarding the integration of floor and cap prices of electricity markets in the smart contract in charge of obtaining prices from the markets. This feature will be detailed later in terms of the smart contract.

The Market 47 panel further comprises a map portion, which shows the place to which the selected market corresponds; and a Hub-Load Zones section, which refers to specific areas within the selected electricity market where electricity demand is centralized. In the Hub-Load Zones section it is also possible to indicate the specific areas within the selected electricity market that are available for trading at a given time.

In addition, the Market Overview section 35 displays the Liquidation History panel 48, which includes a graph indicating the time at which the selected market price should have been reached, as well as the time at which the price actually occurred, within a specified time period (e.g., one week, one month, etc.).

### c) the Latest Market News 12:

This portion is the same that can be accessed from the user interface of the Trading tab and corresponds to the interface of FIG. 9.

### d) Leader Boards 36:

This portion is optional on the platform, that is, it does not comprise fundamental features for the operation of the decentralized exchange platform with the strict purpose of electricity trading, however, it serves to encourage users to actively participate in the platform.

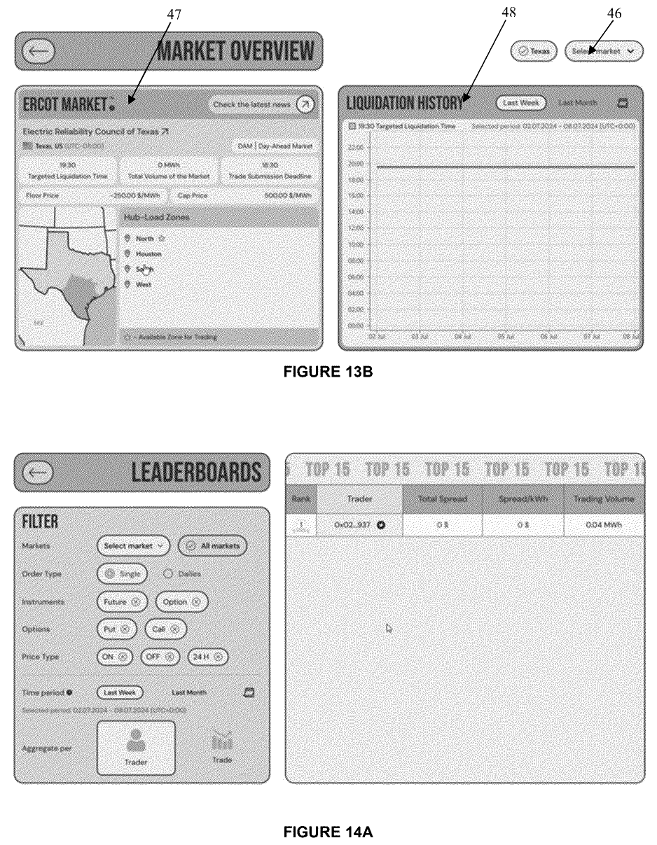

The interface of this section can be seen in FIGS. 14A and 14B. This portion serves to see a list of the users who have made the most trades on the platform during the week and their respective profits (interface of FIG. 14A); or the transactions (trades) that have had the highest profit in the week (FIG. 14B).

The interface comprises a filter panel, which allows filtering this data by market, type of order, instrument, options, price type, period of time, or any other parameter that may be considered useful for users. There is also a panel that shows a list of the users or transactions in question.

Additionally, there is the possibility of sharing the information of a user that appears on this list on social networks. For this, the user's name is selected with a click as it appears in the interface of FIG. 14A, and the social network site is automatically opened (which must be previously saved in the user profile), to be able to share a publication that mentions that the determined user has appeared in the list of leaders of the platform this week.

### e) Electricity Prices 10:

This portion is the same that can be accessed from the user interface of the Trading tab and corresponds to the interface of FIGS. 8A-8C.

### f) Past Trading Data 37:

The last portion of the Information tab is the Past Trading Data portion 37.

This portion allows you to see a record of all the trading operations that have been carried out in the past, of all the users. The difference of this portion with the Recent Trades 9 portion of the Trading tab is that the Recent Trades 9 portion shows only the information of the particular user who is operating the platform, while the Past Trading Data 37 portion shows all the transactions of the decentralized exchange platform.

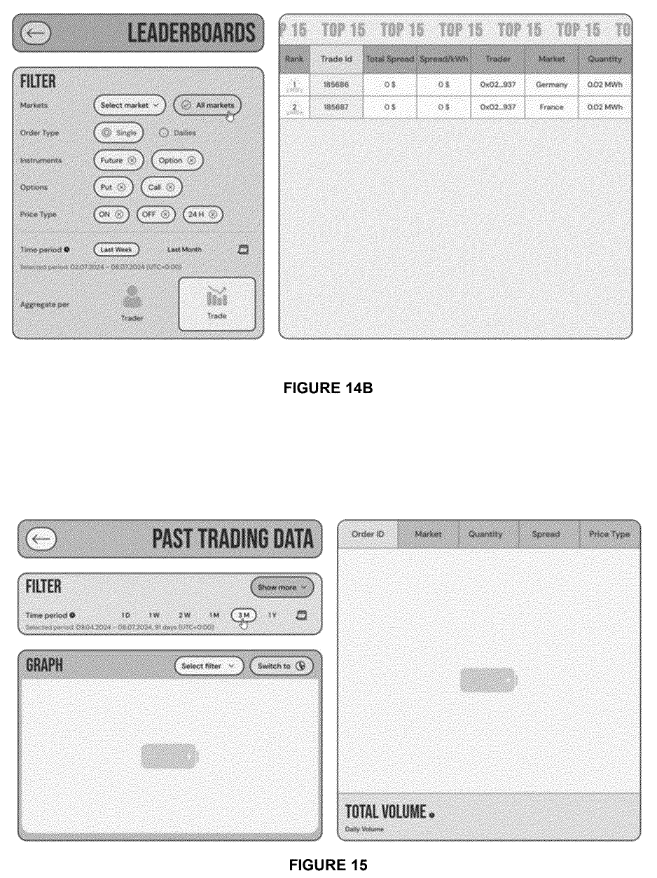

The interface of this portion is shown in FIG. 15, and the following elements are identified:

Main title panel at top;

Filter panel: section that allows you to select a past period of time (for example, a day, a week, a month, etc.);

Graph panel: Graph section that visually indicates the information obtained based on the time filter, respective to each market. There is the possibility of selecting a single market, or several, to view the information in the form of a graph; and

Order list panel: it comprises a list of all the orders obtained from the time filter, with the identification of the order number (OrderID), the market, the amount of kW or MW traded, losses or profits for each order, the price type used, and optionally, any other value that is considered useful for platform users. This panel also includes an indication of the total volume of energy traded of all the orders shown in this list.

Finally, the last tab of the exchange is the Staking tab.

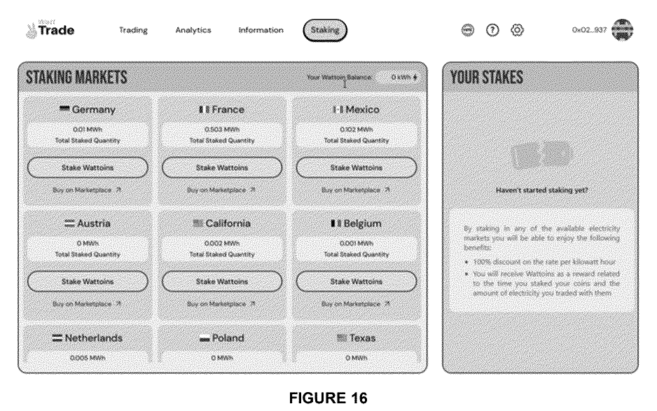

FIG. 16 illustrates the user interface of the Staking tab of the exchange 2 of the platform as described in the present application.

In this tab, users can stake the native token of the platform of the present invention “Wattoin” in different electricity markets, such as, but not limited to, Germany, France, Mexico, Austria, California, Belgium, etc.

FIG. 16 shows that a panel is provided for each of the markets offered on the platform; and each of these panels has a “Stake Wattoins” button to participate, and also an option to buy in the marketplace: “Buy on Marketplace”.

The panel also displays a Your Wattoin Balance indicator (i.e., user Wattoin Balance), so that users know how many tokens (Wattoins) they have available to stake.

Likewise, in the interface there is a second Your Stakes panel, which shows the staking operations that the user has performed.

This is the last tab of the own exchange to the platform described in the present invention, and with the previous paragraphs, the interaction that users have with the user interface of the platform has essentially been described, the operations that can be carried out from the perspective of a user of the platform, and the utility and general information of the blockchain-based decentralized exchange platform (DEX) for electricity trading of the present invention.

### Native Platform Token: “Wattoin”.

The last element of the ecosystem of the platform of the present invention is the native token “Wattoin”. Minted on the Polygon blockchain, the platform's native token ‘Wattoin’ underpins the economy of ecosystem. It is used in the electricity markets, the functionality of the platform, participation in governance and the promotion of liquidity. The deflationary nature of “Wattoin,” coupled with its role in reducing transaction fees and providing voting rights, strengthens the attractiveness of the ecosystem. Each Wattoin is equivalent to one kW of electricity (1000 watts).

Unlike conventional utility tokens, Wattoin combines transactional and governance authority within the exchange, promoting a community platform. It is designed to address challenges in the energy field, facilitating sustainable practices and energy trading beyond traditional limitations, thanks to the security, scalability and speed of blockchain technology.

Particularly in relation to staking, which is carried out in Wattoins on the platform of the present invention, this native token offers users the opportunity to reduce trading fees, and additional rewards to users of this token. This model not only provides savings, but also stabilizes the platform's economy by reducing the circulating supply of Wattoins, mitigating volatility.

This strategy is also designed to appeal to a wide range of users, from small traders to large energy producers, by offering a scalable solution that adapts to their specific business needs and contributes to a balanced and active market.

The possession of Wattoins allows participation in governance, aligning with principles of decentralized finance. Holders can influence key decisions such as technical upgrades, rate adjustments, and integration of new markets. This democratic process is facilitated through a transparent voting mechanism, ensuring integrity and fairness.

In addition, the platform encourages liquidity through liquidity staking. Participants who stake Wattoins on liquidity funds support operational efficiency and receive rewards from transaction fees and tokens. This model fosters a collaborative environment and a stable market, capable of handling transactions without significant price drops.

The incorporation of a deflationary token economy aligns with the standard practices observed between DeFi and Web3 companies. This approach, characterized by controlled reductions in the supply of tokens over time, has emerged as a fundamental strategy within the Web3 ecosystem. Its widespread adoption underscores the recognition by the industry of the inherent value proposition offered by deflationary mechanisms to drive sustained token appreciation and foster strong community engagement.

### Platform Architecture and Programming.

As already mentioned, the platform uses smart contracts to automate and secure electricity trading on its exchange. These contracts are the operational basis of the platform, and facilitate a wide range of transactions, such as futures and options, ensuring transparency, efficiency and equity in liquidations.

The smart contracts of the present platform operate on the Polygon® network, leveraging its scalability and efficiency to manage transactions and liquidations in USDC for transactions and MATIC for gas fees, with kilowatt-hour (KWh) as the unit of measurement for electricity.

These smart contracts, as well as the fundamental parameters of the platform are described in detail in the following categories.

### I. Formulas

Before defining the operations and functionalities that can be carried out on the platform of the present invention, the formulas that serve as the basis for the execution of the functions of the platform, organized by their respective applications, will be described in detail.

It is noted that these formulas are considered in the smart contracts used for the functionalities of the platform of the present invention, as this will be defined later.

### a) Formulas Related to Order Placement Functions.

Firstly, the formulas on which the processes for placing futures and options orders are based will be explained

Particularly, the processes to which these formulas are applied are appreciated in the operations and functionalities shown in FIGS. 3-7D respective to the Add New Order 14 and Withdraw Funds 32 sections of the Recent Trades 9 portion, as well as the Match Order operation detailed in FIG. 12B, and the respective description of said Figures.

All transactions referenced in the formulas of this section are liquidated using kilowatt hours as a unit amount. The units of measurement of electricity are handled as small, medium and large, respectively, as shown below:

$$1 Megawatt = 1 , 000 kilowatts = 1 , 000 , 000 Watts$$

Below, the formulas for carrying out a transaction and with which liquidation is carried out are described:

### Futures:

It is the obligation between two parties to exchange agreed cash flows at a fixed price. There is no physical delivery of the underlying electricity, there is only liquidation in USDC when the operator publishes the prices. The following formulas are considered when creating an offer to buy or sell:

| | |
|---|---|
| Sell (Offer) price | (Maximum Loss − Seller |
| | Working Capital) + Fees |
| Buy (Bid) price | (Maximum Loss + Buyer |
| | Working Capital) + Fees |

Wherein:

Sell (Offer) price: It is the amount to be deposited in the Smart Contract when a trader presents an offer to sell electricity on the platform of the present invention, expresses his willingness to provide a specific amount of energy at a specific price, committing to comply with this obligation once the market price is liquidated.

Buy (Bid) price: It is the amount to be deposited in the Smart Contract when a trader makes an offer to buy electricity on the platform of the present invention, undertakes to acquire a specific amount of energy at an agreed price, being obliged to comply with this obligation.

### Options:

It is an agreement between two parties that gives the option buyer the right to buy or sell at a certain price at a specific future date. When the option is exercised, the seller of the option must deliver the contract at the strike price.

The following formula explains the amount to be deposited by each party in the Smart Options Contract:

| | CALL | PUT |
|---|---|---|
| Buy | Maximum Loss + Fees | Maximum Loss + Fees |
| Sell | Maximum Loss + Fees | Maximum Loss + Fees |

### b) Maximum Loss Formulas.

### Maximum Loss Calculation:

It measures potential losses, considering floor and cap prices against futures offers or bids, or the strike price and prime for options, all multiplied by the amount of kWh.

It is measured using either the cap or floor with the offer and bid of futures, or the strike price and prime of an option multiplied by the KWh.

| | FUTURE MAXIMUM LOSS |
|---|---|
| Buy | (Floor Price* − 1) * KWh) |
| Sell | (Cap Price * KWh) |

### Wherein:

Cap Price: The maximum price at which a market price can be liquidated, this is defined by the governance of the native token “Wattoin” for each market and marks the amount of guarantees that the seller must deposit.

Floor Price: The minimum price at which a market price can be liquidated, this is defined by the governance of the native token “Wattoin” for each market and marks the amount of guarantees that the buyer must deposit. This value is usually negative.

OPTION MAXIMUM LOSS

| | CALL | PUT |
|---|---|---|
| Sell | [(Cap Price − | [(Strike Price + |
| | Strike Price − Prime) * | (Floor Price * − 1) − |
| | KWh] | Premium) * KWh] |
| Buy | Prime* KWh | Prime * KWh |

### Wherein:

Cap Price: The maximum price at which a market price can be liquidated, this is defined by the governance of the native token “Wattoin” for each market and marks the amount of guarantees that the seller must deposit.

Floor price: The minimum price at which a market price can be liquidated, this is defined by the governance of the native token “Wattoin” for each market and marks the amount of guarantees that the buyer must deposit.

Strike price: The “Strike price” at which users can participate in the market by executing an option contract automatically.

Prime: It is the fee that the buyer must pay the seller to guarantee the transaction.

### c) Working Capital Formulas:

### Working Capital Requirement:

It is the result of multiplying the buying or selling price by the amount of kWh of a future.

For an option, it is the strike or prime price (depending on whether it is a buy or sell) for the amount of kWh. The result of the following formulas is considered the Working Capital for each party.

FUTURES WORKING CAPITAL

| | |
|---|---|
| Sell (Offer) price | Offer price * KWh |
| Buy (Bid) price | Bid price * KWh |

### Wherein:

Sell (Offer) price: It is the price you will be paid for selling the electricity to the buyer at the specified price. Once the trader approves the market prices, he will be paid the value of the local marginal price.

Buy (Bid) price: It is the price at which you must pay the energy to the seller at the specified price. Once the market prices are approved by the market operator, you will be paid the value of the local marginal price.

OPTIONS WORKING CAPITAL

| | |
|---|---|
| Sell | Strike Price * KWh |
| Buy | Prime* KWh |

### Wherein:

Strike price: The “Strike price” is the price at which users can participate in the market by executing an option contract.

Prime: It is the fee that the buyer must pay the seller to guarantee the transaction.

### d) Formulas of Order Liquidation Process.

After depositing the maximum loss and working capital, and once the market price has been published by the operator, each of the parties will be liquidated and will receive the equivalent of the amount deposited less or more result according to the following formulas:

| | FUTURES LIQUIDATION |
|---|---|
| Sell | Seller Maximum Loss + [Buyer Working |
| | Capital − (Market price * KWh)] |
| Buy | [Buyer Maximum Loss − Seller Working |
| | Capital] + (Market Price * KWh)] |

### Wherein:

Selling: Once the market prices have been agreed, the buyer pays the seller the agreed price for the purchased electricity (Working Capital). The seller receives from the Smart Contract a payment equivalent to the value of the Local Marginal Price (LMP) published by the market operator.

Buying: Once the market price is liquidated, the buyer pays the seller the agreed price for the purchased electricity (Working Capital), and the buyer receives a payment of the Smart Contract and equivalent to the value of the local marginal price (LMP) published by the market operator.

OPTION LIQUIDATION

| | |
|---|---|
| CALL | PUT |

First situation (the
transaction is carried out):

| | | |
|---|---|---|
| Condition: | If Market Price is higher than | If Market Price is less than |
| | Strike Price, then it is | Strike Price, (Market Price < |
| | received: | Strike Price), then it is |
| | | received: |
| Selling | (Seller Maximum Loss) − | (Seller Maximum Loss) − |
| | [(Market Price*KWh) − | [Seller Working Capital − |
| | Seller Working Capital] | (Market Price *KWh)] |
| Buying | (Market Price *KWh) − | (Market Price *KWh) − |
| | Buyer Working Capital | Buyer Working Capital |

Second situation (the
transaction does not take place):

| | | |
|---|---|---|
| Condition: | If Market Price is less than | If Market Price is higher |
| | Strike Price, (Market Price < | than Strike Price: |
| | Strike Price) | |
| Selling | Maximum Loss + Buyer | Maximum Loss + Buyer |
| | Working Capital | Working Capital |
| Buying | Buyer working capital | Buyer working capital |

### Wherein:

Strike price: The “Strike price” is the price at which users can participate in the market by executing an option contract.

Buyer Working Capital: It is the fee paid by the buyer to the seller to secure the position of the option. Market Price: It is the Local Marginal Price published by the corresponding market operator.

### e) Special Considerations.

The price at which users can place new orders or match live orders is divided into three different options.

A 24-hour day is taken into consideration, in which users will have three channels in which they will place their offers and bids and market price will be liquidated accordingly.

The platform uses End of Hour (HE) to liquidate its transactions, HE is normally denoted by the completion of one hour on the clock. In electricity, “End of Hour” is commonly used to specify the conclusion of a one-hour period.

It is considered an “off-peak” time that is the average from 11:00 p.m. to 6:00 a.m. the next day; and the “peak” hours, which is the average from 7:00 a.m. to 10:00 p.m.

### II. Storage of Electricity Prices of the Relevant Markets:

As already discussed above, the platform uses a specific smart contract to monitor and present the updated prices of the electricity markets of several countries.

This smart contract lays the foundations for the integration of floor and cap prices from electricity markets, ensuring transaction security and guaranteeing liquidity in a simplified manner.

Specifically, relating this smart contract with the user interface of the platform, this smart contract is particularly appreciated in the Market Overview 35 portion as it was described in previous paragraphs.

The smart contract used for this function is the Central Electricity Price Contract, which stores all electricity prices, for all markets, all types of prices, every day. All Escrow Smart contracts query this contract for pricing data, by querying energy pricing APIs, and the DEX backend.

The particular functions performed based on this smart contract are the following:

### “Electricity Prices by Day” Function:

This function recovers all electricity prices for a specific day.

The Electricity Prices by Day function is activated by the user, and comprises the steps of:
verifying the caller (msg.sender),
verifying that the requested day is valid and correctly formatted;
querying the electricity price database for the requested day by accessing the storage of electricity prices on the blockchain and allowing retrieval of relevant price data for the specified date; and
returning as a response the array of prices for the given day, making it available for further processing or display on the frontend.

### “Electricity Prices by Day and Market” Function:

This feature provides users and Escrow Smart contracts with timely access to electricity price information for specific days and markets, by retrieving all electricity prices for a specific day and market.

The Electricity Prices by Day function is activated either by the user or by the execution of the Escrow Smart Contract, which is one of the smart contracts used for the placement of orders, futures and options, as this will be seen below, and comprises:
verifying that the request is authenticated, ensuring that either a user or escrow smart contracts initiated the call;
extracting the specified day and market from the input parameters: day STRING and market STRING;
querying the relevant data by accessing the stored electricity prices for the given day and market from the blockchain's state, which contains historical pricing data;
returning the results in the form of an array that lists the electricity prices; and
updating relevant data, if necessary, based on the execution of the query.

### “Set Electricity Prices Per Market & Day” Function:

The DEX backend calls this feature whenever new prices are available for a specific market. It stores chain, off-chain and 24-hour prices. This function is exclusive to the administrator.

This function ensures that the DEX backend can efficiently update and store current electricity prices, allowing accurate and timely business information to be obtained.

The Set Electricity Prices for Market & Day function is activated by the DEX backend, and comprises:
verifying the caller (msg.sender), ensuring that the request is coming from the DEX backend;
extracting the input parameters related to the day, market and prices of the DEX backend, which is connected to external data providers or APIs that offer real-time electricity prices for different markets and days;
storing the price data, including on-, off-, and 24 h-prices, in the blockchain's state by writing data to a deep hashmap structured as follows: Day->Market->Type->Price;
emitting a “Price Received” event to notify that new price data has been successfully recorded; and
updating the on-chain data structure, adding the new price data for the specified market and day.

### III. Placing Orders, Futures and Options

As this was discussed in the “Ecosystem of the platform” part, a large part of the transactions that can be carried out by the blockchain-based decentralized exchange platform (DEX) for electricity trading consist of the placement of futures and options orders. This is defined, in general terms, in the following manner:

Order placement: Users can create new orders or match existing ones by specifying transaction parameters.

Futures and Options: These are the two main types of contracts available to trade.

Futures involve the exchange of cash flows based on a fixed price, while options give the buyer the right to buy or sell electricity at a specific price at a future date.

These processes are mainly appreciated in what is described for the Trading tab of the exchange of the present application, particularly, the operations and functionalities described in the description of FIGS. 3-7D, respective to the Add New Order, and Withdraw Funds sections of the Recent Trades 9 portion, as well as the Match Order operation shown in FIG. 12B, and described in the explanation thereof.

In the platform of the present invention, the execution of orders for both futures and options are based on the following smart contracts:
Escrow Smart Contract: It allows actions such as placing sell and buy orders for options, as well as placing and canceling futures orders for a specific day.

Escrow smart contract DAILIES: It allows actions such as placing sell and buy orders for options, as well as placing and canceling orders for future DAILIES. All “dailies” orders are essentially simple orders that are repeated every day for periods of one week or one month.

The two contracts depend on some external contracts, such as Currency Contracts, Staking Contracts, and Energy Pricing Contracts, which are necessary for their proper functioning and execution within the ecosystem.

The particular functions that can be performed based on these two smart contracts are the following, separated by each contract:

### a) if Escrow Smart Contract is Executed.

### “Place Option Sell Order” Function.

This function allows a user to present (submit) an option sell order on the platform. It carries out various validations, calculates the liquidity requirements and manages the necessary funds, storing the order data.

The Place Option Sell Order function is activated by the user, and comprises the steps of:
receiving the operation related parameters: quantity, price type, start and end date of liquidation, prime, type of operation (call or put) and value, which are input by the user in the platform;
verifying that the user (msg.sender) is authenticated;
validating that the quantity, strike price and prime are within predefined bounds before adding the information to a block;
validating that the strike price is a valid whole number per MW price point to maintain the consistency and accuracy of the transaction data within the block;
validating that the liquidation date is within acceptable limits, ensuring that it is not more than two years in the future and not too close to the current date;
verifying that the order number is unique and has not been previously used on the platform to ensure that each transaction is different and can be correctly referenced in the blockchain;
verifying that the price type corresponds to a valid type of transaction in the system;
calculating the liquidity requirements for the user based on the corresponding formula, which includes the maximum fee payable per kilowatt of the order;
ensuring that the user has provided the required liquidity, wherein if the amount provided exceeds the requirement, the exact amount is retained and the surplus is returned to the user;
recording the transaction by transferring the placement fee to the platform fee account, where the transfer is included in a new block, and the transaction details are hashed and linked to the blockchain;
storing the remainder of the user's deposit in the smart contract, the storage being recorded in the blockchain, and the contract state being updated and included in the block;
recording the order data in the contract order map, associating it with a unique order number (orderId), wherein the state of the contract is recorded in a new block and the data is hashed and linked to blockchain;
emitting an “Order Placed” event containing all the relevant data for the backend to process, creating a log entry in the blockchain which is included in the block; and
receiving the confirmation of the order number (orderId) and the “Order Placed” event once the order has been successfully placed in the system.

In particular, the consideration of floor and cap prices in transactions of the Place Option Sell Order type are observed in the following steps of the method:

Validation of Parameters within Predefined Limits:

In the step of “validating that the amount, strike price and prime are within predefined limits before adding the information to a block”, the predefined ranges of the strike price and prime are influenced by the floor and cap prices of the markets.

### Ensure Prices are Valid:

In the step: “validating that the strike price is a valid integer per MW price point to maintain the consistency and accuracy of the transaction data within the block”, the valid prices that are established may be influenced by the market floor and cap prices, ensuring that the operations are carried out within acceptable ranges.

### Calculation of Liquidity Requirements:

In the step of “calculating the liquidity requirements for the user based on the referenced formula, which includes the maximum fee to be paid per kilowatt of the order”, the key calculation of the maximum loss and the guarantees that the buyer must deposit are made. This is done using a formula that can include floor and cap prices, considering the size of the order and the conditions of the option.

This calculation implies the maximum loss, since it is mentioned that a formula is used to determine the liquidity requirements. According to the section related to formulas, this includes the maximum rate per kilowatt, which implies the calculation of the maximum loss using the limit prices (cap price and floor price) of the electricity markets. The necessary guarantees are determined from this calculation.

### “Place Option Buy Order” Function:

This function allows the user to send an option buy order to the platform. It carries out the different validations and checks, relates the buy order with the existing sell order, calculates the liquidity requirements considering the corresponding parameters, collects the necessary funds from the user and stores the order data and the relationship with the sell order.

The Place Option Buy Order function is activated by the user, and comprises the steps of:
receiving the operation related parameters that are input by the user in the platform: quantity (quantity UINT) and value;
verifying that the user (msg.sender) is authenticated;
validating that the order number of the Sell Order to which the Buy Order refers: exists and has sufficient remaining quantity, and meets the percentage criteria ensuring at least a minimum of 5% of the Sell Order's quantity is available;
ensuring that the Buy Order is placed within the allowed timeframe for the Sell Order, which is between the day in course and prior to the beginning of the liquidation period;
verifying that the Buy Order number is unique and has not been previously used;
calculating the liquidity requirements for the user based on the corresponding formula, including the full fee to be paid per kilowatt of the Buy Order;
ensuring that the user has provided the correct amount of liquidity, wherein if more liquidity than required has been provided, the exact amount is retained and the surplus is returned to the user;
transferring the placement fee to the platform fee account, wherein the transaction is included in a new block on the blockchain and the transfer details are hashed and linked to the blockchain ledger;
storing the remainder of the user's deposit in the contract;
increasing the quantity counter purchased in the Sell Order by the quantity of the Buy Order by updating the Sell Order record in the smart contract to reflect the new quantity bought;
recording the Buy Order in the contract's order map, reference the order number of Sell Order and the quantity by adding the Buy Order to the smart contract's order map, and hashing and storing this data in a new block in the blockchain;
emitting an “Order Placed” event containing all the relevant data for the backend to process, creating a log entry on the blockchain that can be observed by external systems and providing a record of the transaction for backend processing; and
receiving the confirmation of the order number of the Buy Order and the “Order Placed” event once the order has been successfully processed and registered in the blockchain.

For this function, consideration of floor and cap prices in transactions of the Place Option Buy Order type are observed in the method step:

### Calculation of Liquidity Requirements:

In the step of “calculating the liquidity requirements for the user based on the formula referred to, including the full fee to be paid per kilowatt of the buy order”, the key calculation of the maximum loss and the guarantees that the buyer must deposit are made. This is done using a formula that includes floor and cap prices, considering the size of the order and the conditions of the option; wherein step of validating that the order number of the sell order to which the buy order refers comprises determining the type of operation (PUT or CALL) associated with the order in order to identify the corresponding calculation formula.

This calculation implies the maximum loss, since it is mentioned that a formula is used to determine the liquidity requirements. According to the section related to formulas, this includes the maximum rate per kilowatt, which implies the calculation of the maximum loss using the limit prices (cap price and floor price) of the electricity markets. The necessary guarantees are determined from this calculation.

### “Place Future Order” Function:

This function allows the user to send a futures order to the platform. It carries out the different validations and checks, calculates the liquidity requirements considering the relevant parameters, collects the necessary funds from the user and stores the order data.

The Place Future Order function is activated by the user, and comprises the steps of:
receiving the operation related parameters: quantity, price type, liquidation end date and price, if the side is buy or sell, liquidation price date and value, which are input by the user in the platform;
verifying that the user (msg.sender) is authenticated;
validating that the quantity and liquidation price are within acceptable bounds;
ensuring that the prices are set for a valid price point per MW and are whole numbers.
validating that the liquidation date is valid and within the allowed timeframe, which is a maximum of 2 years in the future and prior to the current liquidation period;
verifying that the order number is unique and has not been previously used;
checking that the price type is valid;
calculating the liquidity requirements for the user using the corresponding formula, including the maximum fee to be paid per kilowatt;
ensuring that the user has provided the correct amount of liquidity, wherein, if more liquidity than required is provided, the exact amount is retained and the surplus is returned to the user;
transferring the placement fee to the platform fee account, wherein the transaction is included in a new block on the blockchain and the transfer details are hashed and linked to the blockchain ledger;
storing the remainder of the user's deposit in the contract;
consulting the current kilowatt counter variable for the combination of the side (buy or sell), liquidation date, price type and liquidation price; and
calculating the start kilowatt and end kilowatt variables for the order;
consulting the order counter and storing the placement index, thus determining the position and availability of the order in the blockchain;
storing the order in the contract's order map, including the information from the obtained start kilowatt and end kilowatt variables, thus associating the order associating with the calculated kilowatt values, and then recording and hashing the data in a new block on the blockchain;
updating the liquidation period counter in the smart contract with updated order statistics, such as the new number of buy/sell orders placed and the new number of kilowatts available on the buy/sell side, and recording the data in the blockchain to keep track of the available resources;
issuing an “Order Placed” event containing all the relevant data for the backend to process, creating a log entry on the blockchain that can be observed by external systems and providing a record of the transaction for backend processing; and
once the block containing the future order has been confirmed, receiving confirmation of the Order number and the “Order Placed” event, indicating that the order has been successfully processed and registered.

In this case, the consideration of floor and cap prices in transactions of the Place Future Order type are observed in the following steps of the method:

### Ensure Prices are Valid:

In the step: “ensuring that prices are established for a valid price point per MW and are integers”, the valid prices that are established may be influenced by the market floor and cap prices, ensuring that the operations are carried out within acceptable ranges.

### Calculation of Liquidity Requirements:

In the step of “calculating the liquidity requirements for the user using the corresponding registered formula, including the maximum fee to be paid per kilowatt”, the key calculation of the maximum loss and the guarantees that the buyer must deposit are made. This is done using a formula that can include floor and cap prices, considering the size of the order and the conditions of the option.

This calculation implies the maximum loss, since it is mentioned that a formula is used to determine the liquidity requirements. According to the section related to formulas, this includes the maximum rate per watt, which implies the calculation of the maximum loss using the limit prices (cap price and floor price) of the electricity markets. The necessary guarantees are determined from this calculation.

### “Cancel Order” Function:

This function allows the user to cancel an order only within 5 minutes of placing the buy/sell offer. Check if the requirements for cancellation are met and then delete or update all the relevant order data, returning the user their funds, minus a cancellation fee.

The Cancel Order function is activated by the user, and comprises the steps of:
validating that the order for the Order Number corresponds to an existing order, and that the user (msg.sender) is the original creator of the order,
ensuring that the time threshold for cancellation has not been exceeded and that the price for the Liquidation Day is not yet available;
if it is a sell option order, verifying that the order has not been partially or totally fulfilled yet;
charging the cancellation fee and transferring it to the platform wallet, which is recorded in a new block on the blockchain and wherein the fee transaction details are hashed and added to the blockchain ledger; and
identifying the type of order, wherein:
if the order has been identified as a Future Order, the following steps are performed for updating the smart contract state to reflect the cancellation:
storing the placement Index of the order and the quantity in the corresponding cancellations array,
decreasing the total kilowatts counter in the Liquidation Period Count hashmap accordingly, and
maintaining the orders Placed counter unchanged to maintain accurate placement indices for future orders;
if the order has been identified as a Buy-Option Order, the following step is performed for adjusting the related sell-option record in the smart contract:
reducing the kilowatts bought counter in the associated sell-option order; and
if the order has been identified as a Sell-Option Order, the following step is taken to remove the sell-option order record from the smart contract:
deleting the order from the system;
deleting or updating in the smart contract the order data itself to reflect its canceled status;
returning the remaining funds to the user, and recording the transaction in a new block in blockchain;
emitting an event “Order Canceled” that that creates a log entry on the blockchain and includes all relevant data for the backend to process; and
receiving the confirmation of the cancellation and the “Order Canceled” event once the block containing the cancellation is confirmed, and the order has been successfully processed and recorded on the blockchain.

### “Withdraw Order” Function:

This function allows the user to withdraw the returns obtained from their operation from the smart contract. Verify that the order is ready to be withdrawn, then verify if the order was matched, partially matched or not matched at all and, if it was at least partially matched, calculate the results (spread) of the operation using the formulas and the electricity price of the Central Electricity Price contract mentioned above. The remaining funds (either more than the user deposited, in case of profit; or less, in case of loss) are sent back to the user, and an operation fee per watt is sent to the platform wallet.

The Withdraw Order function is activated by the user, and comprises the steps of:
validating that the order is an existing order and that the user (msg.sender) is the user who placed the order;
ensuring that a price for the liquidation day exists by querying it from the Central Electricity Price Contract;
determining whether the order was matched, partially matched, or not matched based on an identified type of order, wherein:
if the order has been identified as a Futures Order,
checking the historical data of the order by assessing the placement Index, start kilowatt, and end kilowatt variables of the order,
looping through the canceled orders to determine the actual start and end kilowatt values, and
evaluating how many kilowatts were matched by comparing with the total kilowatts available on the opposite side;
if the order has been identified as a Sell-Option,
retrieving data on the quantity of kilowatts bought from the buy side by examining the kilowatts bought field; and
if the order has been identified as a Buy-Option,
assuming the buy option is always fully matched, and calculating the return based on the provided quantity;
calculating the total spread of the order using the referenced electricity price and trade outcome formulas;
reserving the amount of kilowatts that were matched and are covered by staked coins eligible for a reduced fee by interacting with the staking contract;
transferring the calculated trading fee to the platform account, recording the transaction in a new block on the blockchain;
transferring the remaining funds to the user, and recording the transaction in the blockchain to reflect the final state of the transaction;
emitting an “Order Withdrawal” event that includes all relevant data for the backend to process, creating a log entry on the blockchain and providing a record of the withdrawal; and
once the block containing the withdrawal is confirmed, receiving the confirmation of the withdrawal and the “Order Withdrawal” event, ensuring that the transaction has been successfully processed and recorded on the blockchain.

### “Pause Contract/Unpause Contract” Function:

This function refers to pausing the contract in case of emergency which means that orders cannot be withdrawn or placed. Triggers an event that the backend detects to show on the frontend that the operation is paused.

The Pause Contract function is activated by the platform administrators, and comprises the steps of:
initiating a contract emergency pause to stop all order placements and withdrawals, changing the smart contract state to an “emergency pause” status; and
trigger a “Contract paused” event that is detected by the backend and reflected on the frontend.

The Unpause Contract function is activated by the platform administrators, and comprises the steps of:
resuming contract operations to allow the placement and withdrawal of orders by changing the contract state to operational; and
triggering a “Contract not paused” event that updates blockchain to notify the backend and frontend that the contract is active and that trading operations are back online.

### b) if Escrow Smart Contract DAILIES is Executed.

### “Place Option Sell Order” Function:

This function allows the user to send a DAILIES option sell order to the platform. It carries out the different validations and checks, calculates the liquidity requirements, the required parameters, collects the necessary funds from the user and stores the order data.

The Place Option Sell Order function is activated by the user, and comprises the steps of:
receiving the parameters related to operation: quantity, price type, liquidation start and end date, strike price, prime, operation type (call/put) and value, which are input by the user on the platform;
receiving the order number (orderID) parameter generated by frontend;
verifying that the user (msg.sender) is authenticated;
validating that the quantity, strike price and prime are within acceptable bounds before adding the information to a block;
validating that the strike price is a valid whole number per MW price point to maintain the consistency and accuracy of the transaction data within the block;
validating the liquidation start and end timestamp parameters by:
calculating the distance between days to determine if the period is weekly or monthly,
verifying that the timestamps are not in the past, fall within the current period or are too far in the future,
if the period is determined to be weekly, ensuring that the timestamps begin on a Monday and end on a Sunday, and
if the period is determined to be monthly, confirming that the timestamps begin on the first and end on the last day of the month;
verifying that the order number (orderId) is unique and has not been previously used on the platform to ensure that each transaction is different and can be correctly referenced on the blockchain;
verifying that the price type corresponds to a valid type of transaction in the system;
calculating the liquidity requirements for the user based on the corresponding formula considering the maximum fee paid for each kilowatt for one day and then multiplying by the number of days in the DAILIES;
ensuring that the user has provided the required liquidity, wherein if the amount provided exceeds the requirement, the exact amount is retained and the surplus is returned to the user;
registering the transaction by transferring the placement fee to the platform fee account, where the transfer is included in a new block, and the transaction details are hashed and linked to the blockchain;
storing the remainder of the user's deposit in the smart contract, the storage being recorded in the blockchain, and the contract state being updated and included in the block;
recording the order data in the contract's order map, associating it with the unique order number (orderId), wherein the contract state is recorded in a new block and the data is hashed and linked to the blockchain;
issuing an “Order Placed” event containing all the relevant data for the backend to process, creating a log entry in the blockchain that is included in the block.

In particular, the consideration of floor and cap prices in transactions of the Place Option Sell Order type are observed in the following steps of the method:

Validation of Parameters within Predefined Limits:

In the step of “validating that the amount, strike price and prime are within acceptable limits before adding the information to a block”, the predefined ranges of the strike price and prime are influenced by the floor and cap prices of the markets.

### Ensure Prices are Valid:

In the step: “validating that the strike price is a valid integer per MW price point to maintain the consistency and accuracy of the transaction data within the block”, the valid prices that are established may be influenced by the market floor and cap prices, ensuring that the operations are carried out within acceptable ranges.

### Calculation of Liquidity Requirements:

In the step of “calculating the liquidity requirements for the user based on the corresponding formula considering the maximum fee paid for each kilowatt for one day and then multiplying by the number of days in DAILIES”, the key calculation of the maximum loss and the guarantees that the buyer must deposit are made. This is done using a formula that includes floor and cap prices, considering the size of the order and the conditions of the option.

This calculation implies the maximum loss, since it is mentioned that a formula is used to determine the liquidity requirements. According to the section related to formulas, this includes the maximum rate per watt, which implies the calculation of the maximum loss using the limit prices (cap price and floor price) of the electricity markets. The necessary guarantees are determined from this calculation.

### “Place Option Buy Order” Function:

This function allows the user to send a DAILIES option buy order to the platform. It carries out the different validations and checks, relates the buy order with the existing sell order, calculates the liquidity requirements, the corresponding parameters, collects the necessary funds from the user and stores the order data and relationship with the sell order.

The Place Option Buy Order function is activated by the user, and comprises the steps of:
receiving the operation related parameters: quantity and value, which are input by the user in the platform;
receiving the parameter order number (orderID) generated by frontend;
verifying that the user (msg.sender) is authenticated;
validating that the order number of the Sell Order to which the Buy Order refers exists, is valid and available, and that it has sufficient remaining quantity to fulfill the Buy Order;
ensuring that the Sell Order is placed within the allowed timeframe for the Sell Order, which is between the liquidation start specified by the sell order and before the current liquidation period;
verifying that the number of the Buy Order is unique and has not been previously taken;
calculating the liquidity requirements for the user based on the corresponding formula, by considering the full fee paid for each kilowatt for one day and then multiplying this amount by the number of days in DAILIES;
ensuring that the user has provided the correct amount of liquidity, wherein if more than required is provided, the exact amount is retained and the surplus is returned to the user;
transferring the placement fee to the platform fee account, wherein the transaction is included in a new block on the blockchain and the transfer details are hashed and linked to the blockchain ledger;
storing the remainder of the deposit in the contract by updating the contract state to reflect the stored deposit amount;
increasing the bought quantity counter in the Sell Order by the quantity of the Buy Order by updating the sell order record in the smart contract to reflect the new quantity bought;
recording the Buy Order in the contract's order map, referencing the order number of Sell Order and the quantity by adding the Buy Order to the smart contract's order map, and hashing and storing this data in a new block in the blockchain;
issuing an “Order Placed” event signaling the successful placement of the Buy Order, containing all the relevant data for the backend to process, creating a log entry on the blockchain that can be observed by external systems, and providing a record of the transaction for backend processing.

The consideration of the floor and cap prices in the transactions of the Place Option Buy Order type can be observed in the following step of the method:

### Calculation of Liquidity Requirements:

Similar to other methods, in the step of “calculating the liquidity requirements for the user based on the corresponding formula, considering the full fee paid for each kilowatt for one day and then multiplying this amount by the number of days in DAILIES” the liquidity that the user needs to provide is calculated based on the full fee paid for each kilowatt per day. This calculation considers the total amount of kilowatts and the days covered by the DAILIES (futures contract). Here, the calculation of the maximum loss is directly related to the amount of kilowatts purchased in the order and the days of operation; wherein step of validating that the order number of the sell order to which the buy order refers comprises determining the type of operation (PUT or CALL) associated with the order in order to identify the corresponding calculation formula.

### “Place Future Order” Function:

This function allows the user to send a future DAILIES order to the platform. It carries out the different validations and checks, calculates the liquidity requirements, the corresponding parameters, collects the necessary funds from the user and stores the order data.

The Place Future Order function is activated by the user, and comprises the steps of:
receiving the operation related parameters: quantity, price type, liquidation end date and price, side (buy or sell) and value, which are input by the user in the platform;
verifying that the user (msg.sender) is authenticated;
validating that the quantity and liquidation price are within acceptable bounds;
verifying that prices are established for a valid price point per MW, allowing only whole numbers;
performing validation of the liquidation start and end timestamp parameters by calculating the distance between days to determine if the order is weekly or monthly, and ensuring that the timestamps are valid and not in the past or current period, where the weekly orders must begin on Monday and end on Sunday, while the monthly ones must begin on the 1st and end on the last day of the month;
verifying that the order number is unique and is not already taken;
confirming that the price type is valid;
calculating the liquidity requirements for the user based on the corresponding formula by considering the maximum fee paid for each kilowatt for one day and multiplying this by the number of days in DAILIES;
ensuring that the user has provided the correct amount of liquidity, wherein if more liquidity than required is provided, the exact amount is retained and the surplus is returned to the user;
transferring the placement fee to the platform fee account, where the transaction is included in a new block on the blockchain and the transfer details are hashed and linked to the blockchain ledger;
storing the remaining deposit in the contract until the order is completed;
querying existing data to determine how the new order fits into the general market by looking up the current kilowatt counter for the specified combination of side, liquidation date, price type and liquidation price to calculate the start and end kilowatt variables for the order;
storing the order in the contract's order map, including the information from the obtained start kilowatt and end kilowatt variables, thus associating the order with the calculated kilowatt values, and then recording and hashing the data in a new block in the blockchain;
issuing an “Order Placed” event containing all the relevant data for the backend to process, creating a log entry on the blockchain that can be observed by external systems and providing a record of the transaction for backend processing, signaling to the backend that a new order has been successfully created.

The consideration of floor and cap prices in transactions of the Place Future Order type are observed in the following steps of the method:

### Calculation of Liquidity Requirements:

In the step of “calculating the liquidity requirements for the user based on the corresponding formula considering the maximum fee paid for each kilowatt for one day and multiplying this by the number of days in DAILIES” the liquidity requirements are calculated based on the maximum fee paid for each kilowatt for one day, multiplied by the number of days in DAILIES. This allows to estimate the amount of liquidity needed to cover any possible maximum loss during the liquidation period. If the market fluctuates against the user, the maximum loss will be limited to the amount of liquidity that has been retained. In addition, any excess liquidity provided is returned, which ensures that the user does not block more capital than necessary.

### Ensure Prices are Valid:

In the step: “verifying that prices are established for a valid price point per MW, allowing only integers”, the valid prices that are established may be influenced by the market floor and cap prices, ensuring that the operations are carried out within acceptable ranges.

### “Cancel Order” Function:

This function allows the user to cancel a DAILIES order. Check if the requirements for cancellation are met and then delete or update all the relevant order data, returning the user their funds, minus a cancellation fee.

The Cancel Order function is activated by the user, and comprises the steps of:
checking that the order for the provided order number exists and that the user (msg.sender) is the user who placed it;
ensuring that the time threshold has not been exceeded by confirming that the price for the day of liquidation start is not available yet;
if it's a sell option order, verifying that no one has partially bought up this option yet;
charging the cancellation fee and sending it to the platform wallet;
identifying the type of order, wherein:
if the order has been identified as a Future Order, the following steps are performed for updating the smart contract state to reflect the cancellation:
storing the placement Index of the order and the quantity in the corresponding cancellations array,
decreasing the total kilowatts counter in the liquidation period count hashmap accordingly, and
maintaining the orders Placed counter unchanged to maintain accurate placement indices for future orders;
if the order has been identified as a Buy-Option Order, the following step is performed for adjusting the related sell-option record in the smart contract:
reducing the kilowatts Bought counter in the associated sell-option order; and
if the order has been identified as a Sell-Option Order, the following step is taken to remove the sell-option order record from the smart contract:
deleting the order from the system;
deleting or updating in the smart contract the order data itself to reflect its canceled status;
sending the remaining funds back to the user; and
emitting an “Order Canceled” event that includes all relevant data for the backend to process, thus logging the cancellation event on the blockchain, providing a clear audit trail for backend processing.

### “Withdraw DAILIES Order” Function:

This function allows the user to withdraw the returns obtained from their operation from the smart contract during liquidation periods from 1 to n. Verify if the order was matched, partially matched or not matched at all (if this has not been done before) and, if it was at least partially matched, go through all the completed liquidation days and calculate the results (spread) of the operation using the formulas and the corresponding daily electricity price of the Central Electricity Price contract as already described. The remaining funds (either more than the user deposited, in case of profit; or less, in case of loss) are sent back to the user, and a trading fee per watt is sent to the platform wallet. A withdrawal of funds is made for each day, that is, if it is weekly, funds are withdrawn 7 times and if it is monthly, 29, 30 or 31 times depending on the month of operation.

The Withdraw DAILIES order function is activated by the user, and comprises the steps of:
checking if the order exists and that the user (msg.sender) is the one who placed the order;
determining whether the order was matched, partially matched, or not matched at all;
if the order has been identified as a Futures Orders,
checking the historical data of the order by assessing the placement Index, start kilowatt, and end kilowatt variables of the order,
looping through the canceled orders to determine the actual start and end kilowatt values, and
evaluating how many kilowatts were matched by comparing with the total kilowatts available on the opposite side;
if the order has been identified as a Sell-Option,
retrieving data on the quantity of kilowatts bought from the buy side by examining the kilowatts bought field; and
if the order has been identified as a Buy-Option,
assuming the buy option is always fully matched, and calculating the return based on the provided quantity;
calculating timeframes for liquidity by:
retrieving the timestamp from the blockchain and extracting the corresponding day,
calculating the number of days between the last recorded liquidation and the current day, wherein if the last recorded liquidation date has not been set, the contract uses the liquidation start date as the starting point,
iterating through days, wherein the contract, beginning from the starting date, iterates over each subsequent day, and or each day performs liquidation calculations by querying the current price from the Electricity Price Contract,
wherein, for futures orders, the system sums up the total price difference over the liquidation period and performs any additional calculations based on the total price difference, and
wherein, for options orders, the contract counts the variables of i) the total positive or negative difference from each liquidation event and ii) the number of times the option was not liquidated but the prime fee was still paid, and these variables are then used to calculate the overall impact of the option on the specified time period, resulting in the overall spread calculation;
wherein, if the current day is being processed, the system checks whether a price has already been set, and if no price exists, the day is disregarded; and
wherein to ensure the contract does not run out of gas, the gasleft( ) function is used to monitor available gas during the loop, wherein if the gas is running low, the loop is halted, and wherein before stopping, the contract finalizes the liquidation for the days already processed, noting the last day for which the user was paid;
once liquidation is completed for all processed days, the contract transfers the fees to the platform and distributes the remaining funds to the user,
wherein a dynamic gas limit can be configured in the frontend to adjust the process based on how many days need to be redeemed;
updating the “recently liquidated” field for the DAILIES order based on the last successful liquidation processed in the loop;
querying the amount of kilowatts covered by staked coins eligible for a reduced fee by calling the staking contract;
transferring the total trading fee for all liquidated periods to the platform account;
transferring the remaining funds for the liquidated periods to the user;
closing the DAILIES if the last liquidation period was liquidated and withdrawn, finalizing the order state in the blockchain and marking it as complete;
emitting a “Withdrawal” event that includes an array-like field denoting all days that were liquidated, creating a log entry on the blockchain for backend processing and providing a record of the withdrawal activities.

### “Pause Contract/Unpause Contract” Function:

This function allows Dex administrators to pause the emergency contract which means that orders cannot be withdrawn or placed. Triggers an event that is detected by the backend to notify the frontend that the negotiation is paused.

The Pause Contract function is activated by the platform administrators, and comprises the steps of:
initiating an emergency pause of the contract to stop all order placements and withdrawals, changing the smart contract state to an “emergency pause” state; and
triggering a “Contract paused” event that is detected by the backend and reflected on the frontend.
The Unpause Contract function is activated by the platform administrators, and comprises the steps of:
resuming contract operations to allow the placement and withdrawal of orders by changing the contract's state to operational; and
triggering a “Contract Unpaused” event that updates blockchain to notify the backend and frontend that the contract is active and that trading operations are back online.

### IV. Staking of Crypto-Assets

As already discussed above, the platform uses a specific smart contract to allow users to stake the crypto assets, particularly, the native token to the “Wattoin” platform.

Relating this smart contract with the user interface of the platform, this smart contract is particularly appreciated in the Staking tab, as it was described in previous paragraphs, and as shown in FIG. 16.

The smart contract used for this function is the Staking Contract, which corresponds to the place where users can stake Wattoins (energy coins equivalent to 1 Kilowatt) to obtain reduced rates for trading.

This contract is externally dependent on ERC20 Energy Coins (a type of token that follows the ERC20 standard on the Ethereum blockchain, designed specifically for energy trading), allowing it to integrate and function effectively within the energy trading ecosystem.

The particular functions performed based on this smart contract are the following:

### “Stake Coins” Function:

This function allows users to stake their currencies on the contract. It takes the user's coins, stores the balance in the contract and issues a “coins bet” event.

The Stake Coins function is activated by the user, and comprises the steps of:
receiving a specific quantity of coins from the user's balance (msg.sender), ensuring proper authorization and preventing unauthorized access;
storing the staked balance in the contract by updating the internal contract state to reflect the new balance of staked tokens, making it accessible for future operations;
issuing a “Coins Staked” event by creating a log entry on the blockchain, notifying listeners about the staking action, and providing relevant data for backend processing.

### “Unstake Coins” Function:

The Unstake Coins function allows users to withdraw the coins that have been stake in the contract. The contract reduces the balance of staked coins and transfers the coins back to the user wallet.

The Unstake Coins function is activated by the user, and comprises the steps of:
checking that the user has sufficient balance to unstake the requested quantity by calling the function that verifies the balance stored in the smart contract;
reducing the in-contract balance by the specified quantity, by updating the balance in the smart contract;
transferring the specified quantity of coins from the smart contract back to the user's wallet; and
emitting a “Coins Unstaked” event to notify the backend and update the user interface. “Query Staking Balance” function:

The Query Staking Balance function allows a user to check the balance of the coins they have staked in a smart contract. The user sends a request and receives as a response the number of coins that have been staked so far.

This query process is efficient and does not incur significant gas costs, as it only reads contract data and does not make changes to the ledger state.

The Query Staking Balance function is activated by the user, and comprises the steps of:
retrieve the staking balance associated with the contract user address; and
return the current balance of staking coins to the user.

### “Query Available Staking Balance for User on Liquidation Day” Function:

The Query Available Staking Balance for user on liquidation day function allows users to check the currently available staking balance, not yet consumed, for a given liquidation day. The user enters a liquidation date, and the function returns the amount of coins that are still available to be used that day.

The Query Available Staking Balance for user on liquidation day function is activated by the user, and comprises the steps of:
validating that the user (msg.sender) requesting the balance is authenticated;
retrieving the available staking balance associated with the provided liquidation day by accessing the smart contract's state to obtain the staking balance;
calculating the quantity of available coins that have not been consumed in previous transactions;
returning the available staking balance recorded in a transaction on the blockchain to the user; and
issuing an event including the quantity of coins available for the specified liquidation day, the event records the staking balance available in blockchain, providing a record for backend processing and auditing.

### Consume Kilowatt for Order Function:

The Consume Kilowatt for Order function is used by the Escrow Smart Contract when a user withdraws an order. The contract sends the maximum quantity of kilowatts that can be consumed from the order. The function then verifies how many kilowatts are currently “stuck” and how many have already been consumed by a specific liquidation date. It calculates how many kilowatts remain to be consumed, records the kilowatts successfully consumed and returns that amount to the Escrow Smart Contract to apply a reduced rate during creation or matching of the order for the equivalent deposited Wattoins.

The Consume Kilowatt for Order function is activated by the user, and comprises the steps of:
validating that the call is made by the Escrow Smart Contract,
retrieving the available staked kilowatts for the specific liquidation date to determine the maximum that can be applied to reduce the fees during the trade's withdrawal;
calculating how many kilowatts have already been consumed for this liquidation date by subtracting the kilowatts already consumed from the staked total for that specific liquidation date;
determining the kilowatts that remain to be consumed by comparing the remaining kilowatts with the maximum allowed quantity that is passed to the function, ensuring that no more than the allowable amount is consumed;
returning the amount of successfully consumed kilowatts to Escrow Smart Contract, allowing blockchain to update user's fee accordingly.

### “Consume Kilowatts for DAILIES Order” Function:

This function looks for how many kilowatts are currently in stake, for each date in the sent matrix, looks for how many have already been consumed for the respective liquidation date and calculates how many kilowatts remain to be consumed for that day. Write the new balances of “kilowatts consumed” per liquidation day and return the total amount of kilowatts consumed correctly to the Escrow Smart contract.

The Consume Kilowatt for DAILIES order function is activated by the user, and comprises the steps of:
validating that the call is made by the DAILIES Escrow Smart contract;
retrieving the available staked kilowatts for each liquidation date in the provided array by accessing the user's staking balance for the specified liquidation dates and checking the available wattage that can be applied for fee reductions;
calculating how many kilowatts have already been consumed for each liquidation date provided by subtracting the kilowatts already consumed from the staked kilowatts;
determining the remaining kilowatts to consume for each liquidation date by comparing the available kilowatts with the maximum allowed per day, ensuring that no more than the amount allowable per date is consumed;
writing to the blockchain ledger the updated consumed kilowatts balances for each liquidation date;
returning the total kilowatts successfully consumed to the DAILIES Escrow Smart contract by sending back the cumulative kilowatt consumption across all dates, which will then apply the corresponding reduced fees.

### V. Entity Sets and Hash Map Structures

The blockchain-based electricity trading platform of the present invention is efficiently structured through the use of various entities and hashmaps that allow optimal management of user orders.

First, the Order Hashmap is one of the key tools for storing user orders, where each order is identified by a unique identifier (orderId).

However, in another embodiment of the invention, it is possible to implement separate hashmaps for different categories of orders, such as option purchases and sales, as well as futures orders. This separation facilitates access to information, and also allows optimizing the management of specific fields that vary between the different types of orders.

Another critical component in the data structure is the “LiquidationPeriodCount”, serving as a detailed record of liquidation days and their corresponding prices. This hashmap is designed to point to an object that contains valuable information, such as liquidation price and kilowatt counters associated with buy and sell orders. These records allow efficient tracking of transaction performance over time, helping to determine the number of kilowatts involved in each liquidation period.

As for temporary management, all the timestamps used in the platform are standardized in UTC format. This ensures that all transactions and records are handled consistently, eliminating any confusion that may arise from time zone differences. This approach also applies to all UNIX timestamps used within the system.

The platform also incorporates a series of key events, which are fundamental to document the actions taken within the smart contract. For example, events such as “Future Order Placed” and “Order Canceled” have specific parameters that detail the nature of the transactions, including data such as the order identifier, the user's address, the market involved, and other relevant attributes. These events are not only crucial for the traceability of operations, but also allow the user interface to receive real-time updates on the state of their orders.

Finally, the structure of the platform is designed to allow deposits to be made in USDC. This implies that electricity prices must also be converted to a compatible format before being stored on the blockchain. To ensure consistency and accuracy in price management, a format that maintains six decimals is chosen, which ensures that transactions are compatible with the USDC format. This attention to detail in the data structure and event management allows the platform to offer a smooth and efficient user experience, facilitating electricity trading in a safe and transparent manner.

### VI. Security and Transparency

The DEX platform for electricity trading described in this text is intended to provide transparency and security to users; therefore, each smart contract used is subject to rigorous Quillaudits® audit reports, which guarantees the highest standards of reliability and trust in each transaction.

The smart contracts of the present platform are continuously evolving and are always focused on increasing automation, reducing settlement times and incorporating more complex trading strategies. The platform is committed to leveraging smart contract technology to improve the transparency, efficiency and security of decentralized electricity trading.

1. A decentralized exchange system for blockchain-based electricity trading, comprising:
one or more non-transitory computer-readable storage media;
one or more processors operatively coupled to the one or more non-transitory computer-readable storage media; and
program instructions stored on the one or more non-transitory computer-readable storage media that, when executed by the one or more processors, configure the system to:
store, using a first smart contract, a plurality of electricity prices from different electricity markets, including respective floor and cap prices for each of the different electricity markets, wherein the electricity prices of the different electricity markets are automatically updated in the system whenever new prices are available for each specific market, wherein a decentralized backend of a blockchain-based system comprised in the decentralized exchange system is configured to activate the storing of the plurality of electricity prices;
manage and secure guarantees for electrical energy transactions using a second smart contract, and also performing, at an instruction of a user, operations to place and/or match futures and/or options orders related to the different electricity markets,
wherein by placing and/or matching futures and/or options orders by instruction of the user, the system is also configured by the second smart contract to verify a liquidity to be deposited in a transaction which is determined by a price input by the user, as well as a market cap or floor prices where the transaction is being performed, according to a required liquidity it is verified that the user has sufficient funds for the transaction and in case it is not complied with, notify the user and prevent a process of placing the order from being completed,
wherein, by placing and/or matching futures and/or options orders by instruction of the user, the system is further configured by the second smart contract to perform a calculation of maximum losses and guarantees that the user must deposit based on the respective floor and cap prices that are determined by platform users through governance that allows voting according to a number of native tokens of the system that each user owns, for each of the different electricity markets where the futures and/or options order is going to be placed or matched; and
wherein the system is further configured by the second smart contract to operate the futures and/or options orders with amounts starting from one kilowatt, limiting a maximum loss determined by maximum and minimum prices established by liquidity of the system; and
using a third smart contract, allow users of the system to stake crypto assets, particularly, the native token of the system,
wherein in managing and securing the guarantees for the electrical energy transactions using the second smart contract, the system is configured to:
emit an “Order Placed” event with respect to a transaction, wherein the transaction comprises placing an option sell order, placing an option buy order, or placing a futures order;
process the transaction;
register the transaction in the blockchain based on completing the processing of the transaction, wherein in registering the transaction, the system is configured to create a log entry in the blockchain with respect to the transaction, based on the “Order Placed” event;
provide confirmation of the transaction based on completing the registering of the transaction in the blockchain; and
perform, using the decentralized backend of the blockchain-based system, backend processing which comprises validating the transaction based of data comprised in the “Order Placed” event.

2. The system according to claim 1, wherein the first smart contract used to cause the system to store a plurality of electricity prices from different electricity markets is a Central Electricity Price smart contract.

3. The system according to claim 2, wherein the Central Electricity Price smart contract executes a Set Electricity Prices for Market & Day function,
wherein the Set Electricity Prices for Market & Day function is activated by a backend of the blockchain-based system, and comprising:
verifying a caller, ensuring that a request comes from the backend of the blockchain-based system;
extracting input parameters related to the day, market and prices from the backend of the blockchain-based system, which is connected to external data providers or APIs that offer real-time electricity prices for different markets and days;
storing price data, including on-, off-, and 24 h-prices, in a blockchain state by writing the data to a deep hash map structured as follows: Day->Market->Type->Price;
issuing a “Price Received” event to notify that new price data has been correctly recorded; and
updating an on-chain data structure, adding the new price data for a specified market and day.

4. The system according to claim 1, wherein the second smart contract that manages and secures the guarantees for electrical energy transactions is one of an Escrow Smart Contract or an Escrow Smart Contract DAILIES.

5. The system according to claim 4, wherein placing and/or matching futures and/or options orders using the Escrow Smart Contract comprises one of:
placing an option sell order;
placing an option buy order; or
placing a futures order.

6. The system according to claim 5, wherein placing an option sell order using the Escrow Smart Contract comprises performing the steps of:
receiving operation related parameters: quantity, price type, start and end date of liquidation, prime, type of operation and value, which are input by the user in the system;
verifying that the user is authenticated;
validating that the quantity, strike price and prime are within predefined bounds before adding the quantity, strike price and prime to a block;
validating that the strike price is a valid whole number per MW price point to maintain a consistency and accuracy of transaction data within the block;
validating that the liquidation date is within a predefined date range ensuring that it is not more than two years in the future and not less than one day from the current date;
verifying that an order number is unique and has not been previously used to ensure that each transaction is different and can be correctly referenced in the blockchain;
verifying that the price type corresponds to a valid type of transaction in the system;
calculating liquidity requirements for the user based on a corresponding formula, which includes a maximum fee payable per kilowatt of the order;
ensuring that the user has provided the required liquidity, wherein if the amount provided exceeds the required liquidity, an exact amount is retained and a surplus is returned to the user;
recording the transaction by transferring a placement fee to a system fee account, where the transfer is included in a new block, and transaction details associated with the transaction are hashed and linked to the blockchain;
storing a remainder of the user's deposit in the smart contract, the storage being recorded in the blockchain, and a contract state being updated and included in the block;
recording order data in a contract order map, associating the order data with a unique order number, wherein the state of the contract is recorded in a new block and the data is hashed and linked to blockchain;
emitting an “Order Placed” event containing all data that identifies the order for the backend to process, creating a log entry in the blockchain which is included in the block; and
receiving the confirmation of the order number and the “Order Placed” event once the order has been successfully placed in the system.

7. The system according to claim 6, wherein in the step of validating that the strike price is a valid whole number per MW price point to maintain the consistency and accuracy of the transaction data within the block, the validity of the strike price per MW price point is calculated based on the market floor and cap prices obtained by the system.

8. The system according to claim 6 or 7, wherein the step of calculating the liquidity requirements for the user based on the corresponding formula, which includes the maximum fee to be paid per kilowatt of the order, further comprises:
calculating the maximum loss and the guarantees that a buyer must deposit,
wherein the used corresponding formula is as follows:
$$( Prime * K W h ) .$$

9. The system according to claim 5, wherein placing an option buy order using the Escrow Smart Contract comprises performing the steps of:
receiving the quantity and value operation related parameters that are input by the user in the system;
verifying that the user is authenticated;
validating that an order number of a Sell Order to which a Buy Order refers exists and has sufficient remaining quantity;
ensuring that the Buy Order is placed within an allowed timeframe for the Sell Order, which is between the day in course and prior to a beginning of a liquidation period;
verifying that a number associated with the Buy Order is unique and has not been previously used;
calculating liquidity requirements for the user based on a corresponding formula, including a full fee to be paid per kilowatt of the Buy Order;
ensuring that the user has provided a correct amount of liquidity, wherein if more liquidity than required has been provided, an exact amount is retained and a surplus is returned to the user;
transferring a placement fee to a system fee account, wherein the transaction is included in a new block on the blockchain and transfer details are hashed and linked to a blockchain ledger;
storing a remainder of the user's deposit in the contract;
increasing a quantity counter purchased in the Sell Order by a quantity of the Buy Order by updating a Sell Order record in the smart contract to reflect a new quantity bought;
recording the Buy Order in the smart contract's order map, reference an order number of Sell Order and a quantity by adding the Buy Order to the smart contract's order map, and hashing and storing this data in a new block in the blockchain;
emitting an “Order Placed” event containing all data that identifies the order for the backend to process, creating a log entry on the blockchain that can be observed by external systems and providing a record of the transaction for backend processing; and
receiving the confirmation of the order number of the Buy Order and the “Order Placed” event once the order has been successfully processed and registered in the blockchain.

10. The system according to claim 9, further wherein:
the step of validating that the order number of the Sell Order to which the Buy Order refers exists and has sufficient remaining quantity further comprises determining a type of operation (PUT or CALL) associated with the order; and
the step of calculating the liquidity requirements for the user based on the corresponding formula, including the full fee to be paid per kilowatt of the Buy Order, further comprises:
calculating the maximum loss and the guarantees that a buyer must deposit, where the used corresponding formula is the corresponding one of the following:
if it is determined that the type of operation is CALL:
$$[ ( Cap price - Strike Price - Prime ) * K W h ] ,$$
if it is determined that the type of operation is PUT:
$$[ ( Strike Price + ( Floor price * - 1 ) - Prime ) * K W h ] .$$

11. The system according to claim 5, wherein placing a futures order using the Escrow Smart Contract comprises performing the steps of:
receiving operation related parameters: quantity, price type, liquidation end date and price, if the side is buy or sell, liquidation price date and value, which are input by the user in the system;
verifying that the user is authenticated;
validating that the quantity and liquidation price are within respective predefined ranges;
ensuring that the prices are set for a valid price point per MW and are whole numbers;
validating that the liquidation date is valid and within an allowed timeframe;
verifying that an order number is unique and has not been previously used;
checking that the price type is valid;
calculating liquidity requirements for the user using a corresponding formula, including a maximum fee to be paid per kilowatt;
ensuring that the user has provided a correct amount of liquidity, wherein, if more liquidity than required is provided, an exact amount is retained and a surplus is returned to the user;
transferring a placement fee to a system fee account, wherein the transaction is included in a new block on the blockchain and transfer details are hashed and linked to a blockchain ledger;
storing a remainder of the user's deposit in the contract;
consulting a current kilowatt counter variable for a combination of the side (buy or sell), liquidation date, price type and liquidation price;
calculating the start kilowatt and end kilowatt variables for the order;
consulting the order counter and storing a placement index, thus determining a position and availability of the order in the blockchain;
storing the order in a contract's order map, including information from the calculated start kilowatt and end kilowatt variables, thus associating the order associating with the calculated kilowatt values, and then recording and hashing the data in a new block on the blockchain;
updating a liquidation period counter in the smart contract with updated order statistics, such as a new number of buy/sell orders placed and the new number of kilowatts available on the buy/sell side, and recording the data in the blockchain to keep track of available resources;
issuing an “Order Placed” event containing all data that identifies the order for the backend to process, creating a log entry on the blockchain that can be observed by external systems and providing a record of the transaction for backend processing; and
once the block containing the future order has been confirmed, receiving confirmation of the Order number and the “Order Placed” event, indicating that the order has been successfully processed and registered.

12. The system according to claim 11, wherein in the step of ensuring that the prices are set for a valid price point per MW and are whole numbers, the validity of the MW price point is calculated based on the market floor and cap prices obtained by the system.

13. The system according to claim 11 or 12, wherein the step of calculating the liquidity requirements for the user using the corresponding formula, including the maximum fee to be paid per kilowatt further comprises:
calculating the maximum loss and the guarantees that a buyer must deposit,
wherein the used corresponding formula is as follows:
if it is determined that the side is sell:
$$( Cap price * ( K W h ) ,$$
if it is determined that the side is buy:
$$( Floor price * - 1 ) * K W h .$$

14. The system according to claim 4, wherein placing and/or matching futures and/or options orders using the Escrow Smart Contract DAILIES comprises one of:
placing an option sell order;
placing an option buy order; or
placing a futures order.

15. The system according to claim 14, wherein placing an option sell order using the Escrow Smart Contract DAILIES comprises carrying out the steps of:
receiving parameters related to operation: quantity, price type, liquidation start and end date, strike price, prime, operation type and value, which are input by the user in the system;
receiving an order number parameter generated by a frontend;
verifying that the user is authenticated;
validating that the quantity, strike price and prime are within respective predefined ranges before adding the quantity, strike price and prime to a block;
validating that the strike price is a valid whole number per MW price point to maintain consistency and accuracy of transaction data within the block;
validating liquidation start and end timestamp parameters by:
calculating a distance between days to determine if a period is weekly or monthly,
verifying that the timestamps are not in a past period, fall within a current period or are more than two years in the future compared to the current date,
if the period is determined to be weekly, ensuring that the timestamps begin on a Monday and end on a Sunday, and
if the period is determined to be monthly, confirming that the timestamps begin on the first and end on the last day of the month;
verifying that the order number is unique and has not been previously used on the system to ensure that each transaction is different and can be correctly referenced on the blockchain;
verifying that the price type corresponds to a valid type of transaction in the system;
calculating the liquidity requirements for the user based on a corresponding formula considering a maximum fee paid for each kilowatt for one day and then multiplying by the number of days in the DAILIES;
ensuring that the user has provided the required liquidity, wherein if the amount provided exceeds a requirement, an exact amount is retained and a surplus is returned to the user;
registering the transaction by transferring a placement fee to a system fee account, where the transfer is included in a new block, and transaction details associated with the transaction are hashed and linked to the blockchain;
storing a remainder of the user's deposit in the smart contract, the storage being recorded in the blockchain, and a contract state being updated and included in the block;
recording order data in a contract's order map, associating the order data with the unique order number, wherein the contract state is recorded in a new block and the data is hashed and linked to the blockchain;
issuing an “Order Placed” event containing all data that identifies the order for the backend to process, creating a log entry in the blockchain that is included in the block.

16. The system according to claim 15, wherein in the step of validating that the strike price is a valid whole number per MW price point to maintain the consistency and accuracy of the transaction data within the block, the validity of the strike price per MW price point is calculated based on the market floor and cap prices obtained by the system.

17. The system according to claim 15 or 16, wherein the step of calculating the liquidity requirements for the user based on the corresponding formula considering the maximum fee paid for each kilowatt for one day and then multiplying by the number of days in the DAILIES, further comprises:
calculating the maximum loss and the guarantees that a buyer must deposit,
wherein the used corresponding formula is as follows:
$$( Prime * K W h ) .$$

18. The system according to claim 14, wherein placing an option buy order using the Escrow Smart Contract DAILIES comprises carrying out the steps of:
receiving operation related parameters: quantity and value, which are input by the user in the system;
receiving a parameter order number generated by a frontend;
verifying that the user is authenticated;
validating that an order number of a Sell Order to which a Buy Order refers exists, is valid and available, and that it has sufficient remaining quantity to fulfill the Buy Order;
ensuring that the Sell Order is placed within an allowed timeframe for the Sell Order, which is between a liquidation start specified by the sell order and before a current liquidation period;
verifying that a number associated with the Buy Order is unique and has not been previously taken;
calculating liquidity requirements for the user based on a corresponding formula, by considering a full fee paid for each kilowatt for one day and then multiplying this amount by the number of days in DAILIES;
ensuring that the user has provided a correct amount of liquidity, wherein if more than required is provided, an exact amount is retained and a surplus is returned to the user;
transferring a placement fee to a system fee account, wherein the transaction is included in a new block on the blockchain and transfer details are hashed and linked to a blockchain ledger;
storing a remainder of the deposit in the contract by updating a contract state to reflect the stored deposit amount;
increasing a bought quantity counter in the Sell Order by the quantity of the Buy Order by updating a sell order record in the smart contract to reflect a new quantity bought;
recording the Buy Order in the smart contract's order map, referencing an order number of Sell Order and a quantity by adding the Buy Order to the smart contract's order map, and hashing and storing this data in a new block in the blockchain; and
issuing an “Order Placed” event signaling successful placement of the Buy Order, containing all data that identifies the order for the backend to process, creating a log entry on the blockchain that can be observed by external systems, and providing a record of the transaction for backend processing.

19. The system according to claim 18, wherein:
the step of validating that the order number of the Sell Order to which the Buy Order refers exists, is valid and available, and that it has sufficient remaining quantity to fulfill the Buy Order further comprises determining a type of operation (PUT or CALL) associated with the order; and
the step of calculating the liquidity requirements for the user based on the corresponding formula, by considering the full fee paid for each kilowatt for one day and then multiplying this amount by the number of days in DAILIES, further comprises:
calculating the maximum loss and the guarantees that a buyer must deposit, where the used corresponding formula is the corresponding one of the following:
if it is determined that the type of operation is CALL:
$$[ ( Cap price - Strike Price - Prime ) * K W h ] ,$$
if it is determined that the type of operation is PUT:
$$[ ( Strike Price + ( Floor price * - 1 ) - Prime ) * K W h ] .$$

20. The system according to claim 14, wherein placing a futures order using the Escrow Smart Contract DAILIES comprises carrying out the steps of:
receiving operation related parameters: quantity, price type, liquidation end date and price, whether the side is buy or sell, and value, which are input by the user in the system;
verifying that the user is authenticated;
validating that the quantity and liquidation price are within respective predefined ranges;
verifying that prices are established for a valid price point per MW and are whole numbers;
performing validation of liquidation start and end timestamp parameters by calculating a distance between days to determine if the order is weekly or monthly, and ensuring that the timestamps are valid and not in a past or current period, where the weekly orders must begin on Monday and end on Sunday, while monthly orders must begin on the 1st and end on the last day of the month;
verifying that an order number is unique and is not already taken;
confirming that the price type is valid;
calculating liquidity requirements for the user based on a corresponding formula by considering a maximum fee paid for each kilowatt for one day and multiplying this by the number of days in DAILIES;
ensuring that the user has provided a correct amount of liquidity, wherein if more liquidity than required is provided, an exact amount is retained and a surplus is returned to the user;
transferring a placement fee to a system fee account, where the transaction is included in a new block on the blockchain and transfer details are hashed and linked to a blockchain ledger;
storing a remaining deposit in the contract until the order is completed;
querying existing data to determine how the new order fits into a general market by looking up a current kilowatt counter for a specified combination of side, liquidation date, price type and liquidation price to calculate start and end kilowatt variables for the order;
storing the order in a contract's order map, including information from obtained start kilowatt and end kilowatt variables, thus associating the order with the calculated kilowatt values, and then recording and hashing the data in a new block in the blockchain; and
issuing an “Order Placed” event containing all data that identifies the order for the backend to process, creating a log entry on the blockchain that can be observed by external systems and providing a record of the transaction for backend processing, signaling to the backend that a new order has been successfully created.

21. The system according to claim 20, wherein in the step of verifying that prices are established for a valid price point per MW and are whole numbers, the validity of the MW price point is calculated based on the market floor and cap prices obtained by the system.

22. The system according to claim 20 or 21, wherein the step of calculating the liquidity requirements for the user based on the corresponding formula by considering the maximum fee paid for each kilowatt for one day and multiplying this by the number of days in DAILIES, further comprises:
calculating the maximum loss and the guarantees that a buyer must deposit,
wherein the used corresponding formula is the corresponding one of the following:
if it is determined that the side is sell:
$$( Cap price * ( K W h ) ,$$
if it is determined that the side is buy:
$$( Floor price * - 1 ) * K W h .$$

23. The system according to claim 4, wherein users can also withdraw, from the Escrow Smart Contract, returns obtained from a futures and/or options order placement or match operation through a Withdraw Order function, which is activated by the user, and comprises the steps of:
validating that the order is an existing order and that the user is the user who placed the order;
ensuring that a price for a liquidation day exists by querying it from a Central Electricity Price Contract;
determining whether the order was matched, partially matched, or not matched based on an identified type of order, wherein:
if the order has been identified as a Futures Order,
checking historical data of the order by assessing a placement Index, start kilowatt, and end kilowatt variables of the order,
looping through canceled orders to determine actual start and end kilowatt values, and
evaluating how many kilowatts were matched by comparing with total kilowatts available on the opposite side;
if the order has been identified as a Sell-Option,
retrieving data on a quantity of kilowatts bought from a buy side by examining a kilowatts bought field; and
if the order has been identified as a Buy-Option,
assuming the buy option is always fully matched, and calculating the return based on a provided quantity;
calculating a total spread of the order using a referenced electricity price and trade outcome formulas;
reserving the amount of kilowatts that were matched and are covered by staked coins eligible for a reduced fee by interacting with a staking contract;
transferring a calculated trading fee to the platform account, recording the transaction in a new block on the blockchain;
transferring remaining funds to the user, and recording the transaction in the blockchain to reflect a final state of the transaction;
emitting an “Order Withdrawal” event that includes all relevant data for a backend to process, creating a log entry on the blockchain and providing a record of the withdrawal; and
once the block containing the withdrawal is confirmed, receiving the confirmation of the withdrawal and the “Order Withdrawal” event, ensuring that the transaction has been successfully processed and recorded on the blockchain.

24. The system according to claim 4, wherein users can also withdraw, from the Escrow Smart Contract DAILIES, returns obtained from a futures and/or options order placement or match operation through a Withdraw DAILIES Order function, which is activated by the user, and comprises the steps of:
checking if the order exists and that the user is the one who placed the order;
determining whether the order was matched, partially matched, or not matched at all;
if the order has been identified as a Futures Orders,
checking historical data of the order by assessing a placement Index, start kilowatt, and end kilowatt variables of the order,
looping through canceled orders to determine actual start and end kilowatt values, and
evaluating how many kilowatts were matched by comparing with total kilowatts available on the opposite side;
if the order has been identified as a Sell-Option,
retrieving data on a quantity of kilowatts bought from a buy side by examining a kilowatts bought field; and
if the order has been identified as a Buy-Option,
assuming the buy option is always fully matched, and calculating the return based on a provided quantity;
calculating timeframes for liquidity by:
retrieving a timestamp from the blockchain and extracting a corresponding day,
calculating a number of days between a last recorded liquidation and a current day, wherein if a last recorded liquidation date has not been set, the contract uses a liquidation start date as a starting point,
iterating through days, wherein the contract, beginning from the starting date, iterates over each subsequent day, and or each day performs liquidation calculations by querying a current price from an Electricity Price Contract,
wherein, for futures orders, the system sums up a total price difference over a liquidation period and performs any additional calculations based on the total price difference, and
wherein, for options orders, the contract counts the variables of i) total positive or negative difference from each liquidation event and ii) number of times the option was not liquidated but the prime fee was still paid, and these variables are then used to calculate an overall impact of the option on a specified time period, resulting in an overall spread calculation;
wherein, if the current day is being processed, the system checks whether a price has already been set, and if no price exists, the day is disregarded; and
wherein to ensure the contract does not run out of gas, a gasleft( ) function is used to monitor available gas during the loop, wherein if the gas is running low, the loop is halted, and wherein before stopping, the contract finalizes the liquidation for the days already processed, noting the last day for which the user was paid;
once liquidation is completed for all processed days, the contract transfers the fees to the platform and distributes remaining funds to the user,
wherein a dynamic gas limit can be configured in a frontend to adjust the process based on how many days need to be redeemed;
updating a “recently liquidated” field for the DAILIES order based on a last successful liquidation processed in the loop;
querying the amount of kilowatts covered by staked coins eligible for a reduced fee by calling the staking contract;
transferring a total trading fee for all liquidated periods to the platform account;
transferring the remaining funds for the liquidated periods to the user;
closing the DAILIES if the last liquidation period was liquidated and withdrawn, finalizing an order state in the blockchain and marking it as complete; and
emitting a “Withdrawal” event that includes an array-like field denoting all days that were liquidated, creating a log entry on the blockchain for backend processing and providing a record of the withdrawal activities.

25. The system according to claim 1, wherein the third smart contract to allow users of the system to stake crypto assets, is a Staking Contract.
